(19) United States
(12) Patent Application Publication
(10) Pub. No.: US 2025/0089714 A1
(43) Pub. Date: Mar. 20, 2025

(54) METHOD OF PROTECTING PLANTS OR SEEDS FROM STRESS INJURY RESULTING FROM ENVIRONMENTAL STRESS

(71) Applicant: BEDOUKIAN RESEARCH, INC., Danbury, CT (US)

(72) Inventors: Rodrigo Oliviera da Silva, Bethel, CT (US); David Zareh Bedoukian, Danbury, CT (US)

(21) Appl. No.: 18/769,579

(22) Filed: Jul. 11, 2024

Related U.S. Application Data
(60) Provisional application No. 63/538,144, filed on Sep. 13, 2023.

(51) Int. Cl. A01N 43/16; A01N 31/06; A01N 35/06; A01N 37/10; A01N 37/18; A01N 43/08; A01P 21/00

(52) U.S. Cl. CPC A01N 43/16; A01N 31/06; A01N 35/06; A01N 37/18; A01N 37/36; A01N 37/42; A01N 43/08; A01P 21/00

(57) ABSTRACT

A method of protecting a plant or seed from stress injury resulting from an environmental stress is disclosed. The method involves applying to at least a portion of the plant or seed a composition having one or more compounds represented by structure (A) described herein. Compositions useful for protecting a plant or seed from stress injury resulting from an environmental stress are also disclosed. The compositions have one or more compounds represented by structure (A) described herein. A method of inducing tolerance in a plant or seed to an environmental stress is disclosed. The method involves applying to at least a portion of the plant or seed a composition comprising one or more compounds represented by structure (A) described herein. Compositions useful for inducing tolerance in a plant or seed to an environmental stress are also disclosed. The compositions have one or more compounds represented by structure (A) described herein.

### RELATED APPLICATION

This application claims the benefit of U.S. Application No. 63/538,144, filed Sep. 13, 2023, which is incorporated herein by reference in its entirety.

### BACKGROUND OF THE DISCLOSURE

### 1. Field of the Disclosure

This disclosure relates to methods for protecting a plant or seed from stress injury resulting from an environmental stress, or for inducing tolerance in a plant or seed to an environmental stress. This disclosure also relates to compositions useful for protecting a plant or seed from stress injury resulting from an environmental stress, or for inducing tolerance in a plant or seed to an environmental stress.

### 2. Description of the Related Art

Environmental stresses arise from conditions that are unfavorable for the optimal growth and development of plants or seeds. Environmental stresses can be classified either as abiotic or biotic. Abiotic stresses are produced by inappropriate levels of physical components of the environment such as temperature extremes (high, low, and freezing temperatures), drought/water deficit, flooding, lack of oxygen, salinity, low light, excess light, UV radiation, or oxidative stresses. Biotic stresses include pests such as predators, parasites, insects, arachnids, nematodes, and pathogens such as bacteria, viruses, fungi and mycoplasms.

Plants are always under constant threat from both biotic and abiotic stresses. The abiotic and biotic stresses are major limiting factors of plant growth and productivity. Crop losses and crop yield losses of major crops such as rice, maize (corn) and wheat caused by these stresses represent a significant economic and political factor and contribute to food shortages in many countries.

Each year these environmental stresses result in billions of dollars worth of vegetative loss resulting from damaged or reduced crop production. Thus, controlling the adverse effects of such environmental stresses on valued plants and crops is both an economic and environmental concern.

The ability of plants to survive from unfavorable conditions is a function of basal and induced tolerance mechanisms. Basal and induced stress tolerance results from complex processes involving several physiological and biochemical changes including, for example, changes in membrane structure and function, tissue water content, protein, lipid, and primary and secondary metabolite composition.

There is a need for controlling the adverse effects of environmental stresses on valued plants and crops. In particular, there is a need for a safe and effective method for protecting plants and seeds from stress injury resulting from abiotic and biotic stresses, thereby enabling optimal growth and development of plants or seeds.

The present disclosure provides many advantages, which shall become apparent as described below.

### SUMMARY OF THE DISCLOSURE

This disclosure relates to methods for protecting a plant or seed from stress injury resulting from an environmental stress, or for inducing tolerance in a plant or seed to an environmental stress. This disclosure also relates to compositions useful for protecting a plant or seed from stress injury resulting from an environmental stress, or for inducing tolerance in a plant or seed to an environmental stress.

This disclosure relates, in part, to a method of protecting a plant or seed from stress injury resulting from an environmental stress. The method involves applying to at least a portion of said plant or seed a composition comprising one or more compounds represented by structure (A):

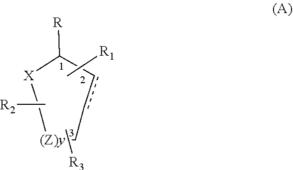

wherein: R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms; X is O or CH₂, with the proviso that when X is O, R can only be ═O; each Z is independently selected from (CH) and (CH₂); y is a numeral selected from 1 and 2; R₁ is selected from H or a branched or straight chain, saturated or unsaturated, hydrocarbyl group with zero to two double bonds and from about 1 to about 15 carbon atoms; R₂ is selected from H and a branched or straight chain, saturated or unsaturated, hydrocarbyl group with zero to three double bonds and from about 1 to about 15 carbon atoms; R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12; the bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in a protective amount sufficient to elicit a protective response in the plant or seed to the environmental stress. When the method is for protecting a seed from stress injury resulting from an environmental stress, the one or more compounds represented by structure (A) are other than a jasmonate.

This disclosure also relates, in part, to a method of inducing tolerance in a plant or seed to an environmental stress. The method involves applying to at least a portion of said plant or seed a composition comprising one or more compounds represented by structure (A):

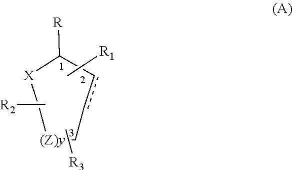

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in an effective amount sufficient to induce tolerance in the plant or seed to the environmental stress. When the method is for inducing tolerance in a seed to an environmental stress, the one or more compounds represented by structure (A) are other than a jasmonate.

This disclosure further relates, in part, to a composition for protecting a plant or seed from stress injury resulting from an environmental stress. The composition includes one or more compounds represented by structure (A):

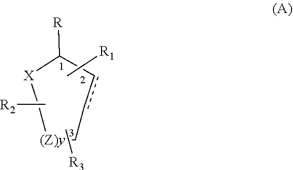

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in a protective amount sufficient to elicit a protective response in the plant or seed to the environmental stress. When the composition is for protecting a seed from stress injury resulting from an environmental stress, the one or more compounds represented by structure (A) are other than a jasmonate.

This disclosure yet further relates, in part, to a composition for inducing tolerance in a plant or seed to an environmental stress. The composition includes one or more compounds represented by structure (A):

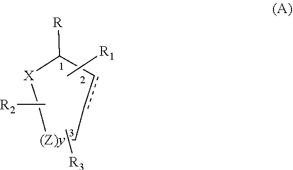

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in an effective amount sufficient to induce tolerance in the plant or seed to the environmental stress. When the composition is for inducing tolerance in a seed to an environmental stress, the one or more compounds represented by structure (A) are other than a jasmonate.

This disclosure also relates, in part, to a method of protecting a plant or seed from stress injury resulting from an environmental stress. The method involves applying to at least a portion of said plant or seed a synergistic composition comprising a synergistic combination of two or more compounds represented by structure (A):

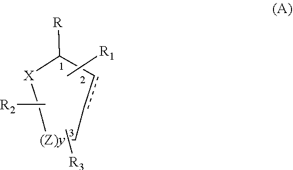

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The two or more compounds of structure (A) are present in the synergistic composition in a protective amount sufficient to elicit a protective response in the plant or seed to the environmental stress. The synergistic combination having a combination of two or more compounds of structure (A) produces, when the plant or seed is treated with the synergistic composition, a combined protection effect, greater than the sum of the separate protection effects, at essentially the same concentrations.

This disclosure further relates, in part, to a synergistic composition for protecting a plant or seed from stress injury resulting from an environmental stress. The synergistic composition includes a synergistic combination of two or more compounds represented by structure (A):

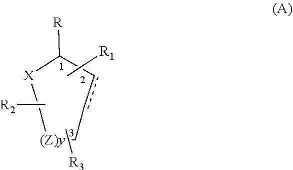

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The two or more compounds of structure (A) are present in the synergistic composition in a protective amount sufficient to elicit a protective response in the plant or seed to the environmental stress. The synergistic combination comprising a combination of two or more compounds of structure (A) produces, when the plant or seed is treated with the synergistic composition, a combined protection effect, greater than the sum of the separate protection effects, at essentially the same concentrations.

This disclosure yet further relates, in part, to a method for inducing tolerance in a plant or seed to an environmental stress. The method involves applying to at least a portion of said plant or seed a synergistic composition comprising a synergistic combination of two or more compounds represented by structure (A):

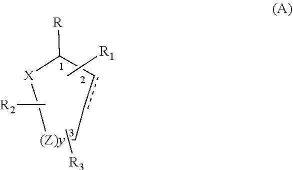

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The two or more compounds of structure (A) are present in the synergistic composition in an effective amount sufficient to induce tolerance in the plant or seed to the environmental stress. The synergistic combination comprising a combination of two or more compounds of structure (A) produces, when the plant or seed is treated with the synergistic composition, a combined protection effect, greater than the sum of the separate protection effects, at essentially the same concentrations.

This disclosure also relates, in part, to a synergistic composition for inducing tolerance in a plant or seed to an environmental stress. The synergistic composition includes a synergistic combination of two or more compounds represented by structure (A):

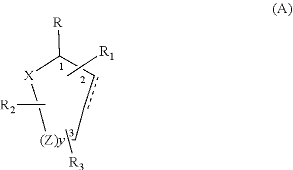

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The two or more compounds of structure (A) are present in the synergistic composition in an effective amount sufficient to induce tolerance in the plant or seed to the environmental stress. The synergistic combination comprising a combination of two or more compounds of structure (A) produces, when the plant or seed is treated with the synergistic composition, a combined protection effect, greater than the sum of the separate protection effects, at essentially the same concentrations.

This disclosure also relates, in part, to a method of seed treatment.

The method comprises applying to at least a portion of said seed a composition comprising one or more compounds represented by structure (A):

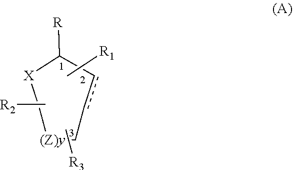

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in an effective amount sufficient to improve a germination characteristic of the seed, as compared to the same germination characteristic of an untreated seed. The one or more compounds represented by structure (A) are other than a jasmonate.

This disclosure further relates, in part, to a method of seed treatment. The method comprises applying to at least a portion of the seed a synergistic composition comprising a synergistic combination of two or more compounds represented by structure (A):

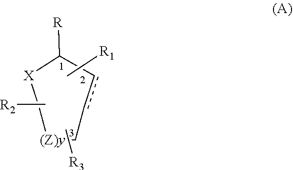

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The two or more compounds of structure (A) are present in the synergistic composition in an amount sufficient to effect a germination characteristic of the seed. The synergistic combination comprising a combination of two or more compounds of structure (A) produces, when the seed is treated with the synergistic composition, a combined germination characteristic effect, greater than the sum of the separate germination characteristic effects, at essentially the same concentrations.

This disclosure yet further relates, in part, to a synergistic composition for improving a germination characteristic of a seed. The synergistic composition comprises a synergistic combination of two or more compounds represented by structure (A):

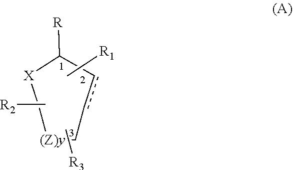

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The two or more compounds of structure (A) are present in the synergistic composition in an amount sufficient to effect a germination characteristic of the seed. The synergistic combination comprising a combination of two or more compounds of structure (A) produces, when the seed is treated with the synergistic composition, a combined germination characteristic effect, greater than the sum of the separate germination characteristic effects, at essentially the same concentrations.

This disclosure also includes optical isomers, diastereomers and enantiomers of the named structures. Thus, at all stereocenters where stereochemistry is not explicitly defined, all possible epimers are envisioned.

Further objects, features and advantages of the present disclosure will be understood by reference to the following detailed description.

### BRIEF DESCRIPTION OF THE DRAWINGS

FIG. 1 graphically shows the average of total dry mass of plants (leaves, stems, reproductive tissues & roots) for T1: untreated, 0.1% ethanol in water as the control, T2: treated, 2.0 mM MDJ in 0.1% ethanol and T3: treated, 2.0 mM MDJ in 0.1% ethanol plus 100 mM of NaCl (sodium chloride, common salt), in accordance with Example 1.

FIG. 2 graphically illustrates % of flowers/plant exhibiting petal wilt and petal wilt severity during 5 days of evaluation for T1: untreated, water as the control, and T2: treated, 1.5 mM MDJ in water plus other inert ingredients, in accordance with Example 2.

FIG. 3 graphically illustrates % of peduncles/plant exhibiting bowing and peduncle bow severity during 5 days of evaluation for T1: untreated, water as the control, and T2: treated, 1.5 mM MDJ in water plus other inert ingredients, in accordance with Example 2.

FIG. 4 graphically illustrates % of plants exhibiting leaf wilt during 5 days of evaluation for T1: untreated, water as the control, and T2: treated, 1.5 mM MDJ in water plus other inert ingredients, in accordance with Example 2.

FIG. 5 shows plants that were subjected to drought stress for T1: untreated, water as the control, and T2: treated, 1.5 mM Methyl Dihydrojasmonate (MDJ) in water plus other inert ingredients) in accordance with Example 2.

FIG. 6 shows plants that were subjected to drought stress after 6 days for T1: untreated, water as the control, T2: treated, 1.5 mM MDJ in water) and T3: (treated, 4.5 mM MDJ in water) in accordance with Example 3.

FIG. 7 shows plants that were subjected to drought stress after 35 days for T1: untreated, water as the control and T3: (treated, 4.5 mM MDJ in water) in accordance with Example 3.

### DESCRIPTION OF THE EMBODIMENTS

In accordance with this disclosure, methods are provided for protecting a plant or seed from stress injury resulting from an environmental stress, or for inducing tolerance in a plant or seed to an environmental stress. Also, in accordance with this disclosure, compositions are provided that are useful for protecting a plant or seed from stress injury resulting from an environmental stress, or for inducing tolerance in a plant or seed to an environmental stress.

The methods and compositions of this disclosure provide enhanced protection for plants and seeds from stress injury resulting from environmental stresses, including enhanced resistance to low temperature/cold stress, freezing stress, high temperature/heat stress, salt/salinity stress, low (shading stress) or excessive light (ultraviolet (UV) radiation and other cosmic radiation), oxidative stress, heavy metal stress, lack of oxygen conditions, flooding, drought/water deficit, viral, fungal and bacterial pathogens and/or combinations thereof.

In accordance with this disclosure, there is provided a method which includes contacting at least one plant or seed, or soil around at least one plant or seed, or at least a part of a plant or seed with a composition of this disclosure. The method improves plant growth, health and protects the plant and seed from stress injury resulting from environmental stresses, or induces plant or seed abiotic and biotic stress tolerance to one or more abiotic or biotic stresses to which the plant or seed is exposed.

As used herein, the term “abiotic stress” refers to those non-living substances or environmental factors which can cause one or more injuries to a plant. Examples of abiotic stresses include those injuries which result from chilling, freezing, hail, flooding, drought, soil compaction, soil crusting and agricultural chemicals such as pesticides and herbicides. For seeds, rapid rehydration during the initial phase of seed germination is considered to be an abiotic stress. Abiotic stresses are produced by inappropriate levels of physical components of the environment such as temperature extremes (high, low, and freezing temperatures), drought/water deficit, flooding, lack of oxygen, salinity, low light, excess light, UV radiation, or oxidative stresses.

As used herein, the term “biotic stress” refers to those living substances which cause one or more injuries to a plant. Examples of biotic stresses include those injuries resulting from infections by insects, nematodes, snails, mites, weeds, pathogens, such as fungus, bacteria or viruses, and physical damage caused by people and animals (i.e., grazing, tredding, etc.). Biotic stresses include pests such as predators, parasites, insects, arachnids, nematodes, and pathogens such as bacteria, viruses, fungi and mycoplasms.

As used herein, the term “environmental stress” refers to a biotic stress or an abiotic stress.

As used herein, the term “stress injury” refers to an injury resulting from an abiotic stress and/or a biotic stress. Examples of abiotic stress injuries include those injuries resulting from temperature extremes (high, low, and freezing temperatures), drought/water deficit, flooding, lack of oxygen, salinity, low light, excess light, UV radiation, or oxidative stresses. Examples of biotic stress injuries include those injuries resulting from infections by insects, nematodes, snails, mites, weeds, pathogens, such as fungus, bacteria, or viruses. Examples of stress injuries include plant death, leaf yellowing, leaf death, no shoot meristem growth, poor shoot meristem growth, plant wilting, loss or degradation of chlorophyll in leaves, leaf browning, leaf wilting or curling, destruction of chloroplasts, leaf lesions, seed death, retarded seed germination, no seed germination, retarded growth (root and shoot) seedlings, no growth (root and shoot) seedlings, retarded rate of seed germination, lower root and shoot fresh weight, reduced seedling vigor, and the like.

As used herein, the term “plant” refers to a whole live plant as well as to any part, tissue or organ from a live plant. For example, the term “plant” includes fruit, flowers, tubers, roots, stems, hypocotyls, leaves, petioles, petals, seeds, etc. The plants can be planted in the terra firma, such as a field, garden, orchard, etc., or can be in a pot or other confined growing apparatus (such as a window box, etc.).

As used herein, the term “seed’ refers to any undeveloped plant embryo and food reserve enclosed in a protective outer covering called a seed coat. Seed refers to anything that can be sown, which can include seed and husk or tuber.

As used herein, the term “germination rate” refers to the percentage of seeds that germinate from a group of seeds that are planted or otherwise placed in conditions that promote germination. The terms “speed of germination” and “faster germination,” as used here, refer to the time span over which a radicle emerges.

In accordance with this disclosure, germination may be considered to be complete once a radicle has emerged, and may also be considered to include aspects of early seedling development, such as radicle length. The phrase “germination characteristic(s)” is meant to encompass germination rate and speed of germination per se, as well as effects on early seedling development that are caused or mediated by exposure to the one or more compounds represented by structure (A) herein. Moreover, the phrase “prior to radicle emergence,” is used to mean that the seeds may either be entirely non-germinated or at some perceptible or imperceptible early stage of the germination process. Some signs of germination, like seed swelling, are easily perceptible, while others are not. The phrase “after radicle emergence,” means perceptible emergence of the embryonic root of the plant from the plumule.

### Active Ingredients

The active ingredients in the compositions of this disclosure include one or more compounds represented by the structure (A):

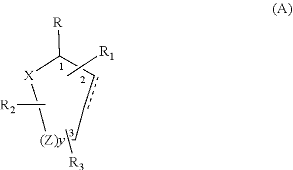

wherein R, X, Z, y, R₁, R₂, and R₃ are as defined hereinabove. The one or more compounds represented by structure (A) are present in the composition in a protective amount sufficient to elicit a protective response in the plant or seed, or in an effective amount sufficient to induce tolerance in a plant or seed to an environmental stress.

In an embodiment, a group of compounds represented by structure (A) are those wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

In an embodiment, a group of compounds represented by structure (A) are those wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₃ is an alkyl or alkenyl group containing at least 3 carbon atoms.

In an embodiment, a group of compounds represented by structure (A) are those wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

In an embodiment, a group of compounds represented by structure (A) include methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone (cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, and 3-methyl-5-heptyl-2-cyclohexenone.

Representative examples of compounds of structure (A) include, but are not limited to,

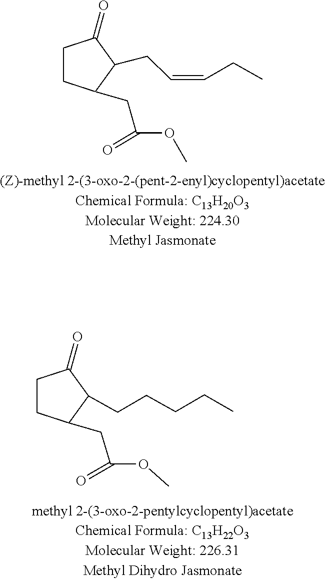 [SMILES: CC/C=C\CC1C(=O)CCC1CC(=O)OC ; CCCCCC1C(=O)CCC1CC(=O)OC]

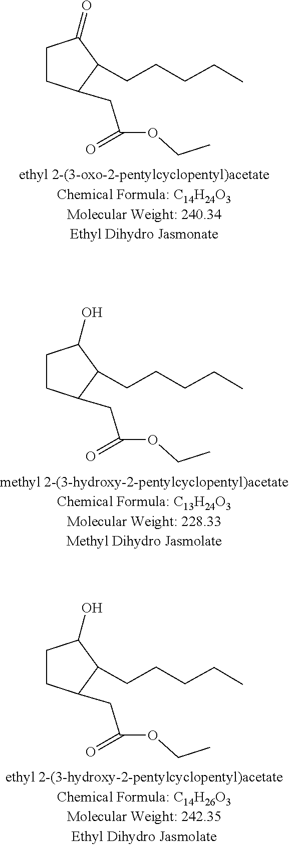 [SMILES: CCCCCC1C(=O)CCC1CC(=O)OCC ; CCCCCC1C(O)CCC1CC(=O)OCC ; CCCCCC1C(O)CCC1CC(=O)OCC]

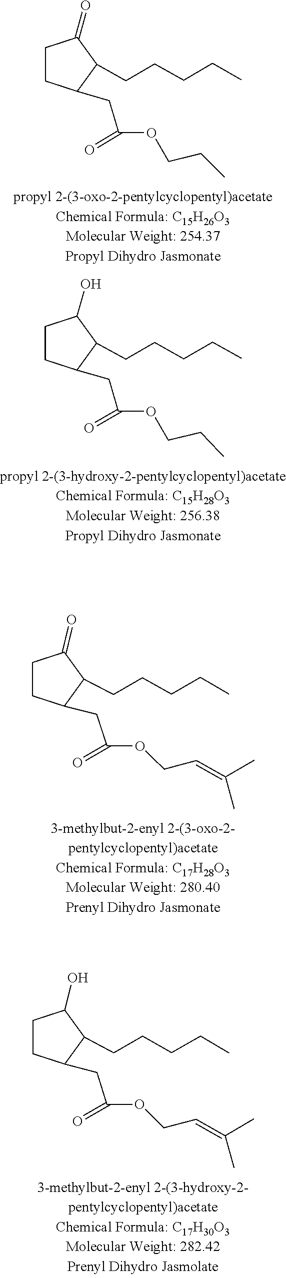 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

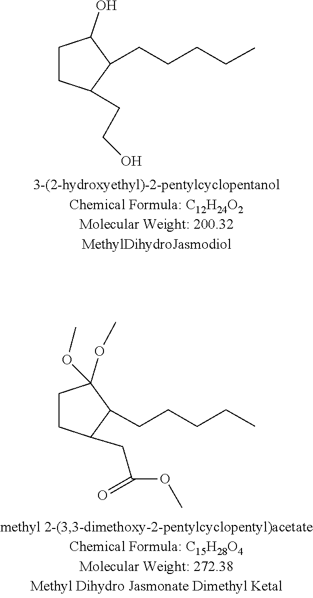 [SMILES: CCCCCC1C(O)CCC1CCO ; CCCCCC1C(CC(=O)OC)CCC1(OC)OC]

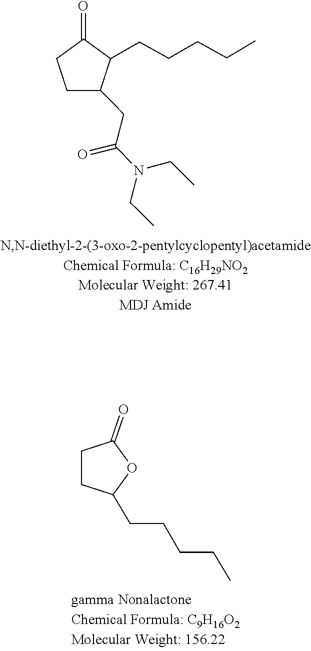 [SMILES: CCCCCC1C(=O)CCC1CC(=O)N(CC)CC ; CCCCCC1CCC(=O)O1]

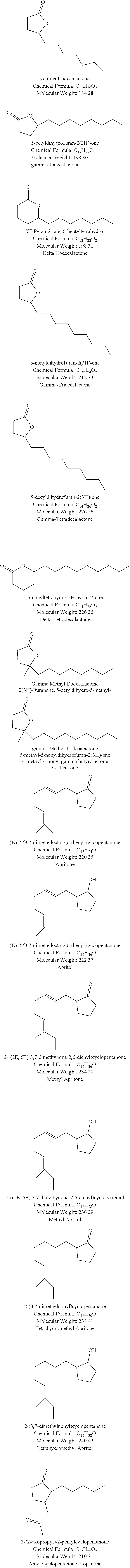

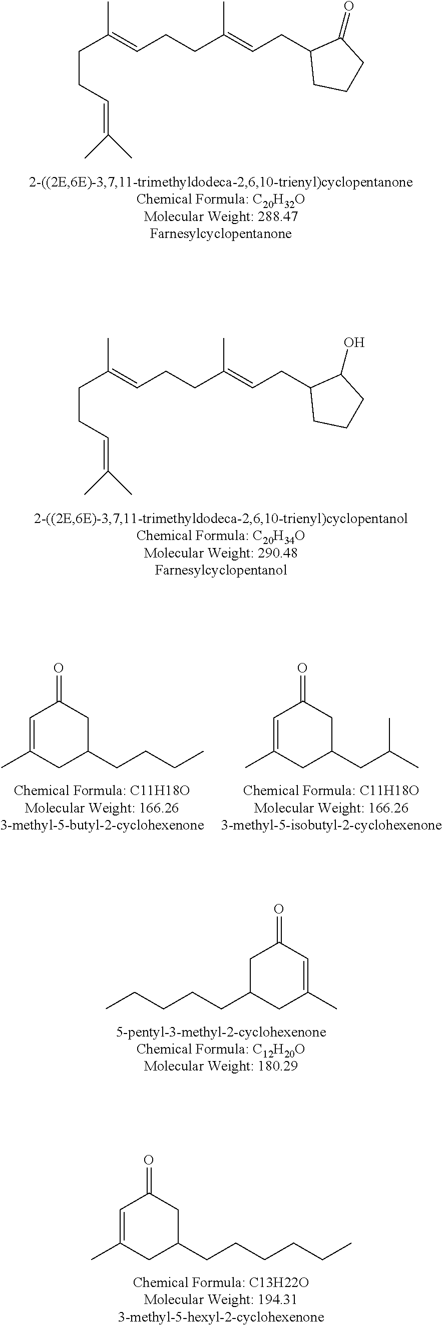

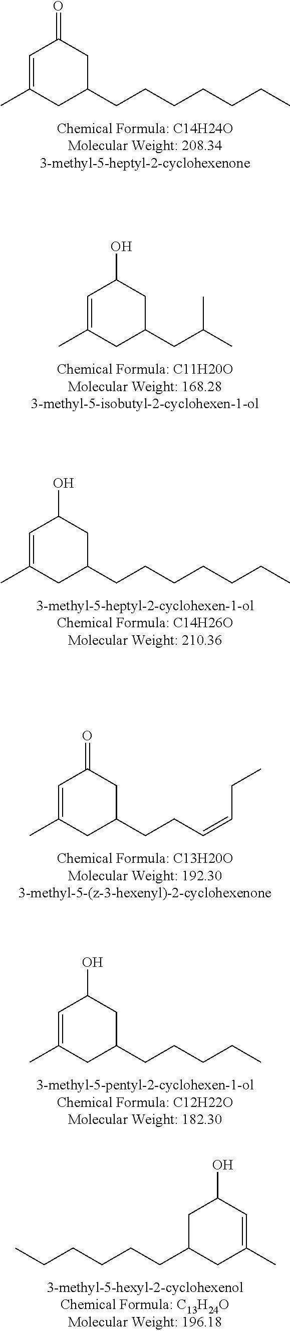

In another embodiment, the composition comprising at least one compound of structure (A) selected from methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone (cyclopentanone, 2-(3,7-dimethyl-2,6-octadienyl)-), and methyl apritone (cyclopentanone, 2-(3,7-dimethyl-2,6-nonadien-1-yl)-), is present in an amount from about 0.0001 to about 50% by weight or greater, based on the total weight of the composition.

In yet another embodiment, the composition comprising at least one compound of structure (A) selected from delta-dodecalactone, gamma-dodecalactone, gamma-undecalactone, gamma methyl dodecalactone, gamma-tridecalactone, gamma methyl tridecalactone, and gamma-tetradecalactone, is present in an amount from about 0.0001 to about 50% by weight or greater, based on the total weight of the composition.

In still another embodiment, the composition comprising at least one compound of structure (A) selected from 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, or 3-methyl-5-heptyl-2-cyclohexenone, is present in an amount from about 0.0001 to about 50% by weight or greater, based on the total weight of the composition.

The one or more compounds represented by structure (A) are present in the compositions of this disclosure in an amount from about 0.0001% by weight to about 50% by weight, or from about 0.0001% by weight to about 40% by weight, or from about 0.0001% by weight to about 30% by weight, or from about 0.0001% by weight to about 20% by weight, or from about 0.0001% by weight to about 10% by weight, or from about 0.001% by weight to about 50% by weight, or from about 0.001% by weight to about 40% by weight, or from about 0.001% by weight to about 30% by weight, or from about 0.001% by weight to about 20% by weight, or from about 0.001% by weight to about 10% by weight, or from about 0.01% by weight to about 50% by weight, or from about 0.01% by weight to about 40% by weight, or from about 0.01% by weight to about 30% by weight, or from about 0.01% by weight to about 20% by weight, or from about 0.01% by weight to about 10% by weight, based on the total weight of the composition.

In an embodiment, the one or more compounds represented by structure (A) are present in the compositions of this disclosure in an amount from about 0.025% by weight to about 50% by weight, or from about 0.025% by weight to about 40% by weight, or from about 0.025% by weight to about 30% by weight, or from about 0.025% by weight to about 20% by weight, or from about 0.025% by weight to about 10% by weight, or from about 0.05% by weight to about 50% by weight, or from about 0.05% by weight to about 40% by weight, or from about 0.05% by weight to about 30% by weight, or from about 0.05% by weight to about 20% by weight, or from about 0.05% by weight to about 10% by weight, or from about 0.075% by weight to about 50% by weight, or from about 0.075% by weight to about 40% by weight, or from about 0.075% by weight to about 30% by weight, or from about 0.075% by weight to about 20% by weight, or from about 0.075% by weight to about 10% by weight, based on the total weight of the composition.

In an embodiment, the one or more compounds represented by structure (A) are present in the compositions of this disclosure in an amount of at least about 0.15 mM (0.003% by weight), or at least about 0.5 mM (0.011% by weight), or at least about 1.0 mM (0.023% by weight), or at least about 1.5 mM (0.034% by weight), or at least about 6.0 mM (0.136% by weight), or at least about 10.0 mM (0.226% by weight), or at least about 20.0 mM (0.452% by weight), in the composition.

The amount of the one or more compounds represented by structure (A) present in the compositions of this disclosure will depend upon the type of formulation used and the particular plant or seed which the formulation is employed.

In an embodiment, the one or more compounds represented by structure (A) are present in the compositions of this disclosure in an amount from about 0.00001 to about 50% by weight or greater, based on the total weight of the composition.

In another embodiment, the one or more compounds represented by structure (A) are present in the compositions of this disclosure in an amount from about 0.0001 to about 30% by weight or greater, based on the total weight of the composition.

In yet another embodiment, the one or more compounds represented by structure (A) are present in the compositions of this disclosure in an amount from about 0.001 to about 25% by weight or greater, based on the total weight of the composition.

In still another embodiment, the one or more compounds represented by structure (A) are present in the compositions of this disclosure in an amount from about 0.01 to about 20% by weight or greater, based on the total weight of the composition.

The amount of the one or more compounds represented by structure (A) present in the compositions of this disclosure will depend upon the type of composition used and the particular plant or seed to which the composition is employed, but will generally range from about 0.00001% to about 50% by weight, from about 0.00001% to about 30% by weight, or from about 0.00001% to about 25% by weight, or from about 0.00001% to about 20% by weight, or from about 0.00001% to about 15% by weight, or from about 0.00001% to about 10% by weight, or from about 0.00001% to about 5% by weight, based on the total weight of the composition.

In an embodiment, when the methods or compositions of this disclosure are for protecting a seed from stress injury resulting from an environmental stress, or for inducing tolerance in a seed to an environmental stress, the one or more compounds represented by structure (A) are other than a jasmonate (i.e., jasmonic acid, derivatives of jasmonic acid, and salts of jasmonic acid).

The compositions described herein can be prepared by any convenient means, e.g., by mixing the active compound of structure (A) with one or more other carriers or vehicles, adjuvants or additives, such as, including but not limited to, those described herein.

### Adjuvants or Additives

The compositions of this disclosure may be used with an agronomically acceptable carrier. The term “agronomically acceptable carrier” includes any carrier suitable for administration to a plant, seed or soil, for example, customary excipients in formulation techniques, such as solutions (e.g., directly sprayable or dilutable solutions), emulsions, (e.g., emulsion concentrates and diluted emulsions), wettable powders, suspensions, soluble powders, powders, dusts, pastes, soluble powders, granules, suspension-emulsion concentrates, encapsulation into polymeric materials, coatable pastes, natural and synthetic materials impregnated with active compound and micro-encapsulations in polymeric substances. These formulations are produced in a known manner, for example, by mixing the compounds with agronomically acceptable carrier, such as liquid solvents or solid carriers, optionally with the use of surfactants, including emulsifiers, dispersants, and/or foam-formers.

If the agronomically acceptable carrier is water, organic solvents can also be employed, for example, as auxiliary solvents. Suitable liquid solvents include, for example, aromatics (e.g., xylene, toluene and alkylnaphthalenes); chlorinated aromatics or chlorinated aliphatic hydrocarbons (e.g., chlorobenzenes, chloroethylenes and methylene chloride); aliphatic hydrocarbons (e.g., cyclohexane); paraffins (e.g., petroleum fractions, mineral and vegetable oils); alcohols (e.g., butanol or glycol and also their ethers and esters); ketones (e.g., acetone, methyl ethyl ketone, methyl isobutyl ketone and cyclohexanone) and strongly polar solvents (e.g., dimethylformamide and dimethyl sulphoxide). Nontoxic carriers are used in the methods of the present disclosure.

Other solid agronomically acceptable carriers include, for example, ammonium salts and ground natural minerals (e.g., kaolins, clays, talc, chalk, quartz, attapulgite, montmorillonite and diatomaceous earth); ground synthetic minerals (e.g., highly disperse silica, alumina and silicates); crushed and fractionated natural rocks (e.g., calcite, marble, pumice, sepiolite and dolomite); synthetic granules of inorganic and organic meals; granules of organic material (e.g., sawdust, coconut shells, maize cobs and tobacco stalks).

The one or more compounds represented by structure (A) can be applied alone or in a formulation comprising other elements, compounds, or substances. Some examples of other compounds useful in the compositions of this disclosure include, for example, wetting agents, adjuvants, emulsifiers, dispersants, spreaders, stickers, pastes, anchorage agents, fixatives, extenders, coating agents, buffering agents, plant nutrients, absorptive additives, and disintegrants. The formulation may also include acids, bases, or other compounds that adjust or maintain the final pH of the composition in order to increase solubility of certain compounds in the composition or for other reasons. Those of skill in the art will recognize that a single ingredient may perform multiple functions, and may thus be classified or grouped in different ways.

The compositions of this disclosure may also include fixative and extender compounds, in order to reduce volatility and evaporation of the active ingredient or ingredients, so as to increase exposure of the plant or seed to the active ingredient. Exemplary fixatives include canola oil, castor oil, benzoyl benzoate, benzyl salicylate and synthetic musks, and sandalwood. Gums, waxes, and other carbohydrates, such as carnauba wax, carob gum, dextrins, dextrose, gellan gum, guar gum, paraffin wax, sorbitol, xanthan gum, polyvinylpyrrolidone, and glycerin, may also be used as fixatives.

Absorptive additives may also be included for extending the release and exposure time. Exemplary absorptive additives include, but are not limited to, silica gel; precipitated crystalline-free silica gel; amorphous, fumed, crystalline-free silica; amorphous, precipitated gel silica; silica hydrate; vitreous silica; silicic acid; and silicon dioxide.

Some emulsifiers and foam-formers that can be used include, for example, nonionic and anionic emulsifiers (e.g., polyoxyethylene fatty acid esters, polyoxyethylene fatty alcohol ethers, for example, alkylaryl polyglycol ethers, alkylsulphonates, alkyl sulphates and arylsulphonates) protein hydrolysates. Suitable dispersants include, for example, lignin-sulphite waste liquors and methylcellulose.

Particular examples of formulation ingredients include ionic, non-ionic, and zwitterionic surfactants, such as TRITON® X-100, TRITON® X-114, NP-40, SILWET, and sodium dodecyl sulfate; alcohols; synthetic or natural oils, such as castor oil, canola (rapeseed) oil, and soybean oil; soaps; and adjuvants derived from natural sources, such as lecithin, saponin, cocodiethanolamide, and extracts from yucca, coconut, and pine. Additionally, for example, citric acid may be used to acidify a formulation, and compounds such as dipotassium phosphate, calcium carbonate, and potassium silicate may be used to raise the pH.

In some embodiments, it may be beneficial to use ingredients that are high in compounds that play a role in the octadecanoic pathway. For example, canola oil is high in linoleic and linolenic acids, compounds that play a role in the octadecanoic pathway. Soaps of linoleic, linolenic, and cis-7,10,13-hexadecatrienoic acids may also be desirable formulation ingredients in some embodiments.

In some embodiments, the compositions may be combined with other active compounds that can be administered in the same fashion as the composition. Examples include fertilizers, seaweed, kelp, humic acid, and microbes. A composition foliar spray may be combined with a foliar fertilizer, and a root solution may be combined with a fertilizer that is applied to the roots. Specific fertilizer and plant nutrient elements include, but are not limited to, nitrogen, potassium, phosphorus, calcium, magnesium, which may be compounded in any known manner so as to be absorbable by the plant or seed. For example, plant nutrients may include monobasic potassium phosphate (KH₂PO₄) and magnesium sulfate (MgSO₄).

The amount of the one or more additives present in the compositions of this disclosure will depend upon the type of composition used and the particular plant or seed to which the composition is employed, but will generally range from about 0.00001% to about 50% by weight, from about 0.0001% to about 30% by weight, or from about 0.001% to about 25% by weight, or from about 0.01% to about 20% by weight, or from about 0.01% to about 15% by weight, or from about 0.01% to about 10% by weight, or from about 0.01% to about 5% by weight, based on the total weight of the composition.

The one or more compounds represented by structure (A) may be present in the compositions of this disclosure in weight/weight ratios of the one or more compounds represented by structure (A) to other ingredients (e.g., adjuvants or additives). The weight/weight ratios can be, for example, about 0.00001/10, or about 0.00001/7.5, or about 0.00001/5, or about 0.00001/2.5, or about 0.00001/1, or about 0.00000/0.75, or about 0.00001/0.5, or about 0.00001/0.25, or about 0.00001/0.1.

### Environmental Stresses

The method of this disclosure protects plants and seeds from stress injury resulting from environmental stresses. Environmental stresses include biotic stresses and abiotic stresses.

Biotic stresses are induced by a living organism such as a virus, bacteria, fungi, viroid, phytoplasma, nematode, insect, pathogen, arachnid, and weed.

Abiotic stresses are induced, for example, by desiccation, salt, drought, osmotic, temperature, wind, water, light, heavy metals, cold, heat, ozone, ultraviolet (UV) radiation, and nutrient deficiency.

### Plants and Seeds

Plants and seeds to which the compositions of this disclosure can be applied to protect against stress injuries resulting from environmental stresses include, but are not limited to, angiosperms, gymnosperms, monocots, dicots, roses, tomatoes, crop plants, ornamental plants, turf plants, shrubs, trees, exotic plants, house plants, and native plants in cultivated or natural environments.

In an embodiment, plants and seeds to which the compositions of this disclosure can be applied to protect against stress injuries resulting from environmental stresses include, for example, those plants and seeds from food crops, forage crops, fiber crops, oil crops, ornamental crops, industrial crops, and the like.

Illustrative food crops include, for example, cereals, fruits, vegetables, spices, and the like.

Illustrative cereals include, for example, wheat, rice, barley, millet, oats, rye, maize, sorghum; the fruits are selected from the group consisting of apples, pears, citrus, stone fruits, tropical fruits, exotic fruits, and berries; the vegetables are selected from the group consisting of root vegetables including beets, carrots, sweet potatoes, turnips; tubers: potatoes, yams; stem vegetables including asparagus, kohlrabi, celery; leafy green vegetables including lettuce, spinach, and silverbeet; allium or bulb vegetables including garlic, leeks, onions, and shallots; head or flower vegetables including artichokes, cabbage, and cauliflower; cucumber family vegetables including pumpkin, cucumber, and zucchini; and spices including pepper, ginger, spice seeds, herbs, and the like.

Illustrative forage crops include, for example, sorghum, alfalfa, barley, oats, millet, soybeans, wheat, maize, hay, silage, and the like.

Illustrative fiber crops include, for example, cotton, hemp, jute, kenaf, flax, and the like.

Illustrative oil crops include, for example, soybeans, sunflower seeds, rapeseed, canola, carmelina, palm, peanuts, and the like.

Illustrative ornamental crops include, for example, ivy, oleander, holly, tulips, roses, azaleas, and the like.

Illustrative industrial crops include, for example, cotton, jute, sugarcane, sugarbeet, coffee, tea, tobacco, coconut, soybeans, and the like.

Illustrative seeds include, for example, cereals, nuts, legumes, spices, and the like.

Contacting a plant or plant part with a composition of the disclosure can result in plant beneficial protection in the root, stem, leaf, seed, flower, and/or combinations thereof. In an embodiment, the plant may be a dicot, a monocot, an annual, a perennial, a crop plant, alfalfa, rice, wheat, barley, rye, cotton, sunflower, peanut, corn, oat, millet, flax, potato, sweet potato, bean, green bean, wax bean, lima bean, pea, chicory, lettuce, endive, cabbage, brussel sprout, beet, sugar beet, parsnip, turnip, cauliflower, broccoli, turnip, radish, spinach, onion, garlic, eggplant, pepper, celery, carrot, squash, pumpkin, zucchini, cucumber, melon, yam, carrots, cassava, citrus, strawberry, grape, raspberry, pineapple, soybean, tobacco, tomato, sorghum, sugarcane, ornamental plant, Arabidopsis thaliana, Saintpaulia, petunia, pelargonium, poinsettia, chrysanthemum, carnation, zinnia, poplar, apple, pear, peach, cherry, almond, plum, hazelnuts, banana, apricot, grape, kiwi, mango, melon, papaya, walnut, pistachio, raspberry, blackberry, loganberry, blueberry, cranberry, orange, lemon, grapefruit, tangerine, avocado, or cocoa, and the like.

### Application and Treatment

In an embodiment, this disclosure relates to a method of protecting plants or seeds from stress injury resulting from environmental stresses by treating the plants or seeds with a protective amount of a composition of this disclosure. The one or more compounds represented by structure (A) of this disclosure may be in a variety of different forms, including emulsions, suspensions, powders, hydrates, solutions, granules, pastes, aerosols, and volatile formulations, and other additives and compounds may be included in the formulation. In one embodiment, the compositions of this disclosure may be in the form of an aqueous solution, accompanied by a surfactant and an oil. The one or more compounds represented by structure (A) of this disclosure may also be provided or co-administered with plant nutrients. After treatment, in some embodiments, the plant or seed, or a portion thereof, may be harvested.

In another embodiment, if the one or more compounds represented by structure (A) of this disclosure are delivered in the form of a solution, they may be in solution with any compatible solvent, including aqueous (water) solutions, alcohol (e.g., ethanol) solutions, or in combinations of solvents (e.g., water/ethanol). In general, a “compatible solvent,” as the term is used herein, refers to any solvent in which the one or more compounds represented by structure (A) of this disclosure are at least slightly soluble and which is not phytotoxic in the amounts or concentrations used to apply the one or more compounds represented by structure (A).

In an embodiment, the composition of this disclosure is used to protect plants and seeds from stress injury resulting from abiotic stress including cold shock, drought/water deficit stress in field applications by applying the composition in an aqueous medium to drip irrigation water/other means of irrigation, or with pesticide or fertilizer application at planting, or post planting during growth season until harvest. Treatment of plants and soil with the composition of this disclosure can be carried out directly or by allowing the compounds to act on the surroundings, environment, or storage space by the customary treatment methods, for example by immersion, spraying, evaporation, fogging, scattering, painting on and, in the case of propagation material, in particular in the case of seeds, also by applying one or more coats. The composition in an aqueous medium can be applied at regular intervals (e.g., every 20-30-day intervals) to the plant roots in the greenhouse or in the field.

The compositions of this disclosure can be applied by coating plant seeds, or germinating seedling roots, before they are planted, or by drenching the roots of existing plants, in situ or in the course of transfer, or by introducing the composition onto the bases of target plants. The application of the composition to target plants protects the plants from stress injury resulting from environmental stresses, for example, pests and pathogens, increases resistance to cold stress, increases drought tolerance, and/or combinations thereof. Application of the compositions of this disclosure to target plants can promote plant growth, health and protects plants from stress injury resulting from abiotic and biotic stresses. Additionally, application of the compositions of this disclosure to target plants can induce plant tolerance to abiotic and biotic stresses including tolerance to low temperature/cold stress, freezing stress, high temperature/heat stress, salt/salinity stress, low (shading stress) or excessive light (ultraviolet (UV) radiation and other cosmic radiation), microgravity stress, which causes flooding response in plants, oxidative stress, heavy metal stress, lack of oxygen conditions, flooding, drought/water deficit, and/or combinations thereof.

The compositions of this disclosure can be administered to the plant, seed, soil, and/or plant environments surrounding the plants by any techniques known in the art, including, for example, spraying, atomizing, dusting, scattering, coating, or pouring. One of skill in the art would be able to determine the appropriate technique for administration without undue experimentation according to the specific abiotic or biotic stress to be combated, the specific chemical composition and formulation of the compound being employed, the method of applying the compound/formulation, and the locus of treatment.

In an embodiment, the compositions of this disclosure can be administered by foliar application. In another embodiment, the compositions can also reach the plants through the root system via the soil by drenching the locus of the plant with a liquid preparation or by incorporating the substances into the soil in solid form, e.g., in the form of granules (soil application). In rice cultivations, these granules can be dispensed over the flooded paddy field. The compositions of the present disclosure may also be applied to tubers or seed grain, for example, by soaking, spraying, or drenching the seed grain or tubers in a liquid composition or by coating the tubers or seed grain with a solid composition.

The active compounds of structure (A) may be formulated into any suitable formulations such as for example, including but not limited to, solutions, aerosols or the like. Traditional inert carriers such as, including but not limited to, alcohols, esters and petroleum distillates, could be used to produce formulations of the active compounds. Another series of carriers are the biodegradable oils, including but not limited to, the Olestra® family of oils, isopropyl myristate and squalane.

When the composition is used as an aerosol, it is preferable to add a propellant. Suitable propellants include propane, butane, isobutane, dimethyl ether, carbon dioxide, nitrous oxide, nitrogen, and combinations thereof.

Forms of the one or more compounds represented by structure (A) may be adapted for application to the plant's foliage, roots, stems, flowers, or any other portion of the plant that is capable of absorbing it. Particularly advantageous forms include foliar sprays, root solutions, and pellet-based root preparations.

As a root solution or preparation, the one or more compounds represented by structure (A) may be formulated and applied to plants grown in soil, non-soil, artificial growing media, and/or hydroponic systems.

In an embodiment, the one or more compounds represented by structure (A) are applied in a “protective amount” sufficient to elicit a protective response in a plant or seed. For purposes of this disclosure, a protective amount of the one or more compounds represented by structure (A) is any amount that elicits a noticeable protective response in a plant or seed, as compared with untreated plants or seeds.

In an embodiment, the one or more compounds represented by structure (A) are applied in an “effective amount” sufficient to induce tolerance in a plant or seed to an environmental stress. For purposes of this disclosure, an effective amount of the one or more compounds represented by structure (A) is any amount that induces noticeable tolerance in a plant or seed to an environmental stress, as compared with untreated plants or seeds.

In another embodiment, the one or more compounds represented by structure (A) are applied in an “effective amount” sufficient to improve a germination characteristic of a seed. For purposes of this disclosure, an effective amount of the one or more compounds represented by structure (A) is any amount that improves a germination characteristic of a seed, as compared with untreated seeds.

Protective amounts and effective amounts of the one or more compounds represented by structure (A) in the compositions of this disclosure will vary from species to species and cultivar to cultivar, and will depend on the manner of application, the environmental conditions around the plant or seeds, the form in which the composition is administered, and the nature and type of additive compounds, if any, present in the compositions.

For example, if a composition is applied over a substantial portion of a plant's foliage, or is applied using a formulation that includes wetting agents, fixatives, and/or other additives intended to increase the level of exposure of the plant to the composition, the formulation itself may contain a smaller amount or lower concentration of the one or more compounds represented by structure (A) than if the composition is applied over only a small portion of a plant's foliage, or without additives intended to increase the plant's exposure to the one or more compounds represented by structure (A). Similarly, if the one or more compounds represented by structure (A) are administered in a form that tends to dwell on the plant's foliage, or in proximity to another part of the plant, then it may be administered in a lower concentration or amount.

As one example, an effective amount of the one or more compounds represented by structure (A) for inducing noticeable tolerance in a plant or seed to an environmental stress may comprise an aqueous solution with a concentration of the one or more compounds represented by structure (A) in the range from about 0.001 wt % to about 5 wt %, inclusive, based on the total weight of the composition. However, for some purposes, and in some species, concentrations up to about 10 wt % may be used. As those of skill in the art will realize, in general, the one or more compounds represented by structure (A) may be used in even higher concentrations for some applications, provided that the total dose of the one or more compounds represented by structure (A) that is absorbed by the plant is not phytotoxic. Similarly, lower concentrations may be adequate in some situations, for example, in an enclosed environment or greenhouse.

In addition to liquid and aqueous preparations, the one or more compounds represented by structure (A) may be formulated for use in a slow-release application and provided in a granular-based or pellet-based form, including fertilizer and/or plant nutrient components. The one or more compounds represented by structure (A) may be present in those formulations in weight/weight ratios of the one or more compounds represented by structure (A) to other ingredients in the range of 0.001% to 10%, and in some cases an effective ratio could be greater than 10% or less than 0.001%. Other inert or nutritive ingredients included in the pellets or granules can include binding agents and polymers, such as polysaccharides and polyvinylpyrrolidone, at 5-95%, a surfactant at 0.001-10%, and other absorptive ingredients, such as acrylamide and acrylamide polymers.

Formulations including the one or more compounds represented by structure (A) may be applied once or repeatedly, depending on the circumstances and the type of formulation, to treat a plant or seed. For example, formulations according to embodiments of this disclosure may be applied to the roots, foliage or some other part of a plant once or, alternatively, two or more times at defined intervals of time, such as every 2-14 days, every 30 days, or 1-2 times per month. The intervals at which the one or more compounds represented by structure (A) are applied may vary. A plant or seed may be treated with the one or more compounds represented by structure (A) whether or not the environmental stress is present at the time of treatment. Additionally, plants and seeds may be treated with the one or more compounds represented by structure (A) for protection from stress injury resulting from environmental stress whether they are healthy or not.

Among other factors, the environmental conditions around the plant or plants may influence the manner in which the one or more compounds represented by structure (A) are applied or their frequency. For example, if the plants are field-grown or otherwise exposed to the elements, rain showers, excessive wind gusts, or other environmental factors shortly after an application, it may be desirable to reapply the one or more compounds represented by structure (A). Under some circumstances, a more dilute formulation or solution may be used if repeated applications are to be performed.

Optionally, in at least some embodiments, a plant treated with the one or more compounds represented by structure (A), or a portion thereof, may be harvested some time after the plant is treated with the one or more compounds represented by structure (A). Harvesting may occur shortly after (e.g., several days after) treatment, or it may occur after sustained, relatively long-term treatment with the one or more compounds represented by structure (A) (e.g., several weeks or several months of treatment at regular intervals).

For foliar application, the compositions of this disclosure can be applied at a rate of 50-1000 ml/acre, or 75-900 ml/acre, or 100-800 ml/acre, or 125-700 ml/acre, or 150-600 ml/acre, or 175-500 ml/acre, or 200-400 ml/acre, of crop.

The composition may be applied to plants or seeds. The composition is applied to the plants or seeds such that the amount of the one or more compounds represented by structure (A) applied is about 0.125 g/m² to about 150 g/m², or about 0.125 g/m² to about 140 g/m², or about 0.125 g/m² to about 130 g/m², or about 0.125 g/m² to about 120 g/m², or about 0.125 g/m² to about 110 g/m², or about 0.125 g/m² to about 100 g/m², or about 0.125 g/m² to about 90 g/m², or about 0.125 g/m² to about 80 g/m², or about 0.125 g/m² to about 70 g/m², or about 0.125 g/m² to about 60 g/m², or about 0.125 g/m² to about 50 g/m², or about 0.125 g/m² to about 40 g/m², or about 0.125 g/m² to about 30 g/m², or about 0.125 g/m² to about 25 g/m², or about 0.125 g/m² to about 20 g/m², or about 0.125 g/m² to about 15 g/m², or about 0.125 g/m² to about 10 g/m², or about 0.125 g/m² to about 5 g/m².

The composition may be applied to plants and seeds to protect the plants and seeds from stress injury resulting from environmental stress, and/or to induce tolerance in plants and seeds to biotic and abiotic stresses.

### Synergy

In an embodiment, a synergistic effect can be exhibited with the formulations of this disclosure.

Depending on the plant species or plant cultivars, their location and growth conditions (e.g., soils, climate, vegetation period, diet), the treatment according to the disclosure may also result in a synergistic effect. Thus, for example, reduced application rates and/or a widening of the activity spectrum and/or an increase in the activity of the substances and compositions to be used, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products that exceed the effects which were actually to be expected may occur.

Additionally, for example, reduced leaf yellowing, reduced leaf death, reduced plant wilting, reduced destruction of chloroplasts, reduced degradation of chlorophyll in leaves, reduced leaf browning, reduced leaf wilting or curling, reduced plant death, reduced leaf lesions, reduced seed death, reduction of retarded seed germination, increased seed germination, reduced plant death, increased shoot meristem growth, reduction of retarded growth (root and shoot) seedlings, increased growth (root and shoot) seedlings, increased rate of seed germination, increased lower root and shoot fresh weight, and/or increased seedling vigor, that exceed the effects which were actually to be expected may occur.

### PREFERRED EMBODIMENTS

Preferred embodiments of this disclosure are set forth in the clauses below.

1. A method of protecting a plant or seed from stress injury resulting from an environmental stress, said method comprising applying to at least a portion of said plant or seed a composition comprising one or more compounds represented by structure (A):

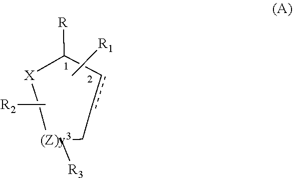

wherein:
   R is selected from —OH, —O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
   X is O or CH₂, with the proviso that when X is O, R can only be ═O;
   each Z is independently selected from (CH) and (CH₂);
   y is a numeral selected from 1 and 2;
   R₁ is selected from H or a branched or straight chain, saturated or unsaturated, hydrocarbyl group with zero to two double bonds and from about 1 to about 15 carbon atoms;
   R₂ is selected from H and a branched or straight chain, saturated or unsaturated, hydrocarbyl group with zero to three double bonds and from about 1 to about 15 carbon atoms;
   R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
   the bond between the 2 and 3 positions in the ring structure may be a single or a double bond;
   wherein the one or more compounds represented by structure (A) contain from about 9 to about 20 carbon atoms, and includes optical isomers, diastereomers and enantiomers of the one or more compounds represented by structure (A);
   wherein the one or more compounds represented by structure (A) are present in the composition in a protective amount sufficient to elicit a protective response in the plant or seed to the environmental stress; and
   wherein, when the method is for protecting a seed from stress injury resulting from an environmental stress, the one or more compounds represented by structure (A) are other than a jasmonate.

2. The method according to clause 1 wherein the one or more compounds represented by structure (A) are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

3. The method according to clause 1 wherein the environmental stress is a biotic stress or an abiotic stress.

4. The method according to clause 3 wherein the biotic stress is induced by a living organism selected from the group consisting of a virus, bacteria, fungi, viroid, phytoplasma, nematode, insect, pathogen, arachnid, and weed.

5. The method according to clause 3 wherein the abiotic stress is selected from the group consisting of desiccation, salt, drought, osmotic, temperature, wind, water, light, heavy metals, cold, heat, ozone, ultraviolet (UV) radiation, and nutrient deficiency.

6. The method according to clause 1 wherein the stress injury comprises plant death, leaf yellowing, leaf death, no shoot meristem growth, poor shoot meristem growth, plant wilting, loss or degradation of chlorophyll in leaves, leaf browning, leaf wilting or curling, destruction of chloroplasts, leaf lesions, seed death, retarded seed germination, no seed germination, retarded growth (root and shoot) seedlings, no growth (root and shoot) seedlings, retarded rate of seed germination, lower root and shoot fresh weight, and/or reduced seedling vigor.

7. The method according to clause 1 wherein the plant or seed is selected from the group consisting of food crops, forage crops, fiber crops, oil crops, ornamental crops, and industrial crops.

8. The method according to clause 7 wherein the food crops are selected from the group consisting of cereals, fruits, vegetables, and spices.

9. The method according to clause 8 wherein the cereals are selected from the group consisting of wheat, rice, barley, millet, oats, rye, maize, sorghum; the fruits are selected from the group consisting of apples, pears, citrus, stone fruits, tropical fruits, exotic fruits, and berries; the vegetables are selected from the group consisting of root vegetables including beets, carrots, sweet potatoes, turnips; tubers: potatoes, yams; stem vegetables including asparagus, kohlrabi, celery; leafy green vegetables including lettuce, spinach, and silverbeet; allium or bulb vegetables including garlic, leeks, onions, and shallots; head or flower vegetables including artichokes, cabbage, and cauliflower; cucumber family vegetables including pumpkin, cucumber, and zucchini; and spices including pepper, ginger, spice seeds, and herbs.

10. The method according to clause 7 wherein the forage crops are selected from the group consisting of sorghum, alfalfa, barley, oats, millet, soybeans, wheat, maize, hay, and silage.

11. The method according to clause 7 wherein the fiber crops are selected from the group consisting of cotton, hemp, jute, kenaf, and flax.

12. The method according to clause 7 wherein the oil crops are selected from the group consisting of soybeans, sunflower seeds, rapeseed, canola, carmelina, palm, and peanuts.

13. The method according to clause 7 wherein the ornamental crops are selected from the group consisting of ivy, oleander, holly, tulips, roses, and azaleas.

14. The method according to clause 7 wherein the industrial crops are selected from the group consisting of cotton, jute, sugarcane, sugarbeet, coffee, tea, tobacco, coconut, and soybeans.

15. The method according to clause 7 wherein the seeds are selected from the group consisting of cereals, nuts, legumes, and spices.

16. The method according to clause 1 wherein the plant is a root, a stem, a leaf, a seed, a flower, or part thereof.

17. The method according to clause 1 wherein the plant is a dicot, monocot, annual, perennial, crop plant, alfalfa, rice, wheat, barley, rye, cotton, sunflower, peanut, corn, oat, millet, flax, potato, sweet potato, bean, green bean, wax bean, lima bean, pea, chicory, lettuce, endive, cabbage, brussel sprout, beet, sugar beet, parsnip, turnip, cauliflower, broccoli, turnip, radish, spinach, onion, garlic, eggplant, pepper, celery, carrot, squash, pumpkin, zucchini, cucumber, melon, yam, carrots, cassava, citrus, strawberry, grape, raspberry, pineapple, soybean, tobacco, tomato, sorghum, sugarcane, ornamental plant, Arabidopsis thaliana, Saintpaulia, petunia, pelargonium, poinsettia, chrysanthemum, carnation, zinnia, poplar, apple, pear, peach, cherry, almond, plum, hazelnuts, banana, apricot, grape, kiwi, mango, melon, papaya, walnut, pistachio, raspberry, blackberry, loganberry, blueberry, cranberry, orange, lemon, grapefruit, tangerine, avocado, or cocoa.

18. The method according to clause 1 wherein the one or more compounds represented by structure (A) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

19. The method according to clause 1 wherein the one or more compounds represented by structure (A) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is-C(O)OR₅, and R₅ is an alkyl or alkenyl group containing at least 3 carbon atoms.

20. The method according to clause 1 wherein the one or more compounds represented by structure (A) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

21. The method according to clause 1 wherein the one or more compounds represented by structure (A) are selected from the group consisting of:

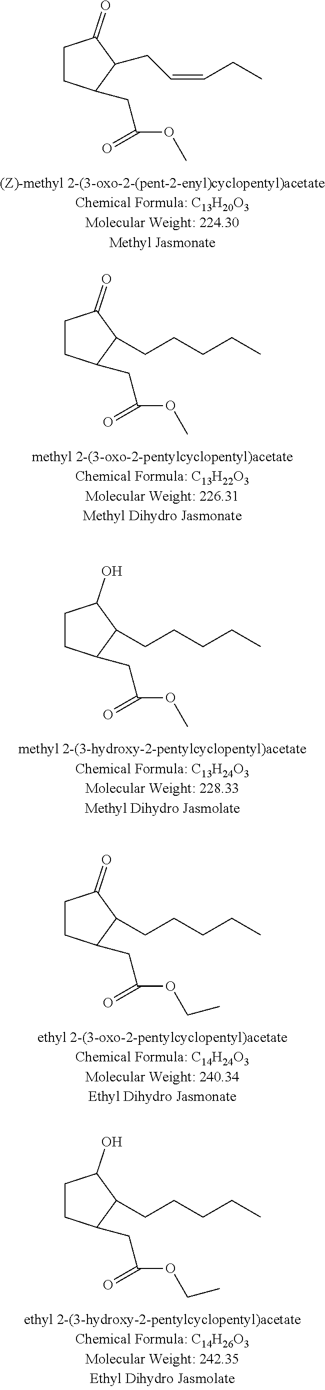 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC ; CCCCCC1C(O)CCC1CC(=O)OCC]

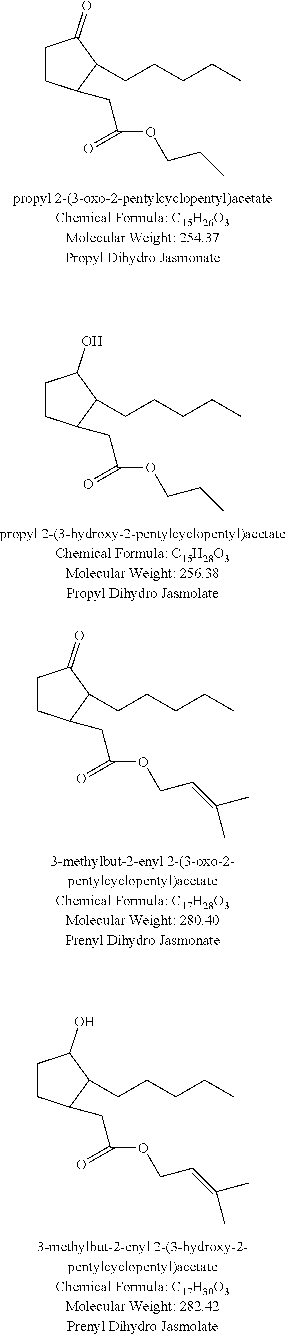 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

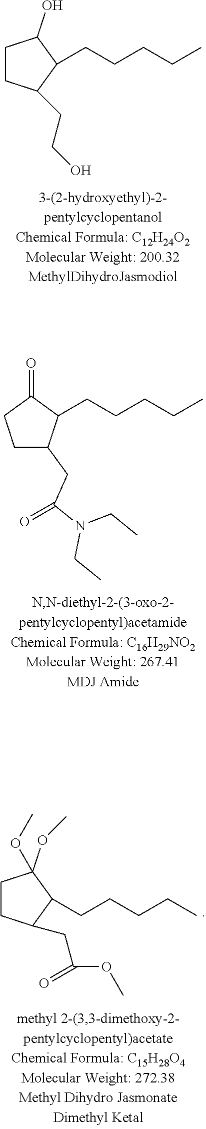 [SMILES: CCCCCC1C(O)CCC1CCO ; CCCCCC1C(=O)CCC1CC(=O)N(CC)CC ; CCCCCC1C(CC(=O)OC)CCC1(OC)OC]

22. The method according to clause 1 wherein the one or more compounds represented by structure (A) are selected from the group consisting of:

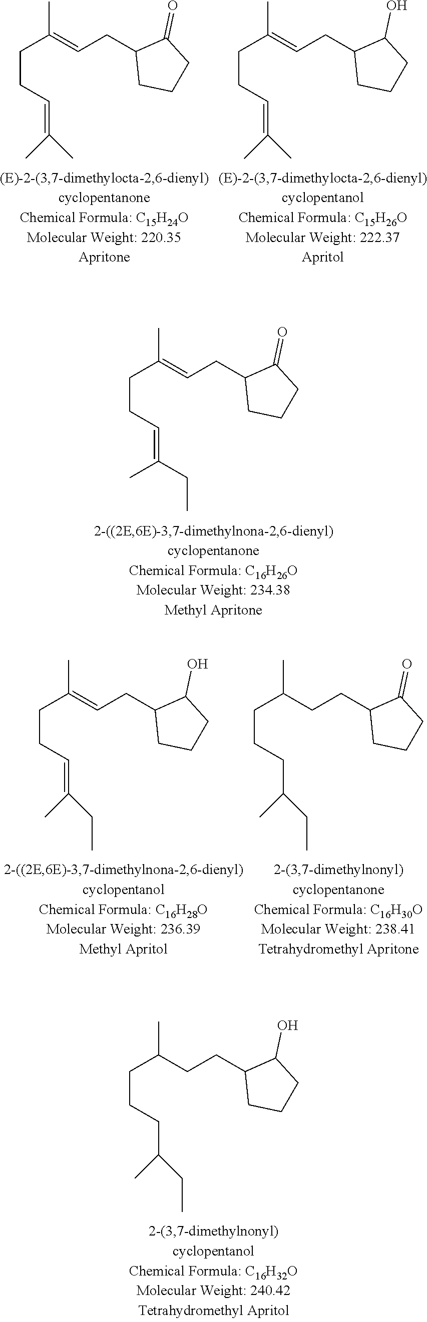 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O ; CCC(C)CCCC(C)CCC1CCCC1O]

23. The method according to clause 1 wherein the one or more compounds represented by structure (A) are selected from the group consisting of:

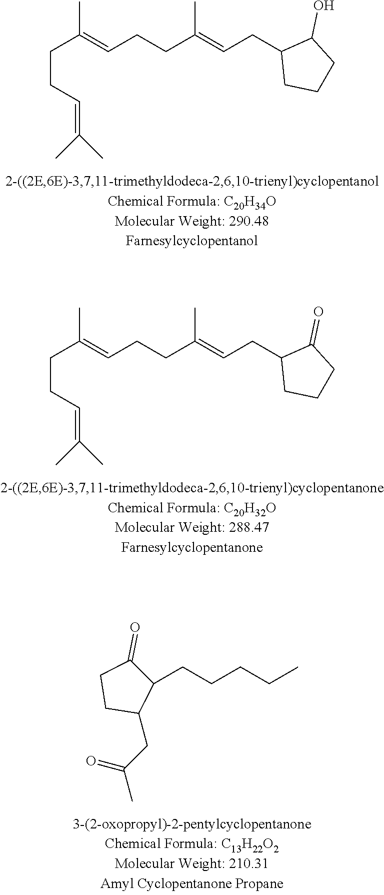 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O]

24. The method according to clause 1 wherein the one or more compounds represented by structure (A) are selected from the group consisting of:

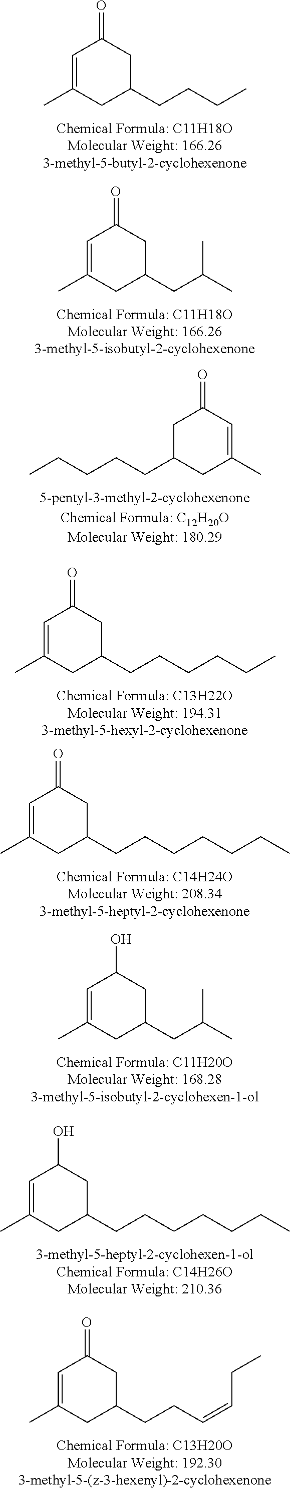

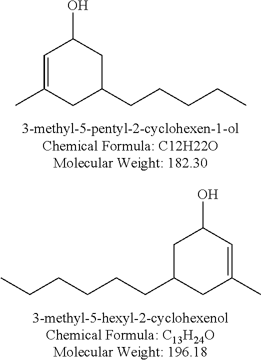

25. The method according to clause 1 wherein the one or more compounds represented by structure (A) are selected from the group consisting of:

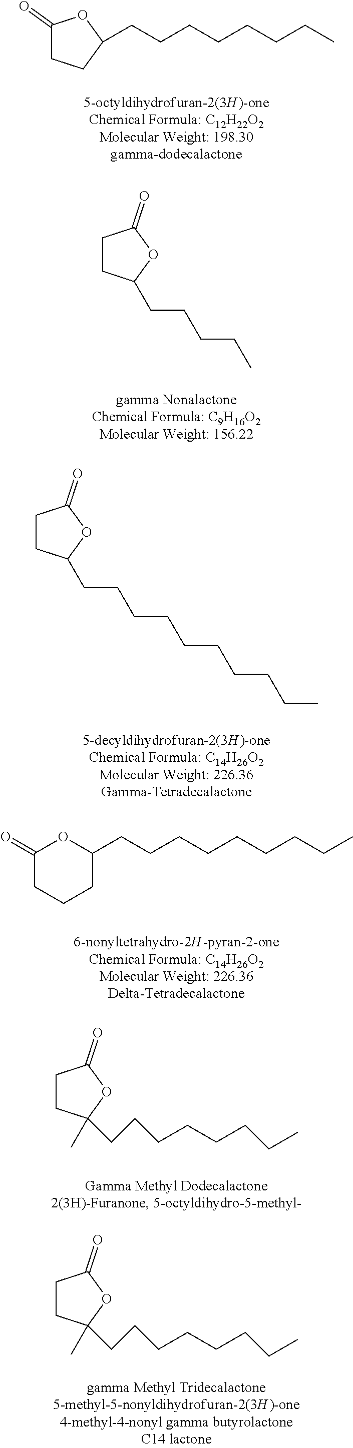 [SMILES: CCCCCCCCC1CCC(=O)O1 ; CCCCCC1CCC(=O)O1 ; CCCCCCCCCCC1CCC(=O)O1 ; CCCCCCCCCC1CCCC(=O)O1 ; CCCCCCCCC1(C)CCC(=O)O1 ; CCCCCCCCC1(C)CCC(=O)O1]

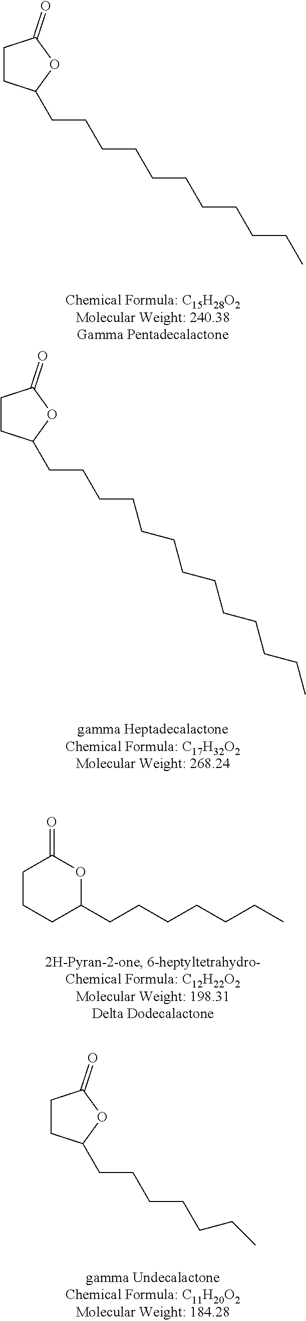 [SMILES: CCCCCCCCCCCC1CCC(=O)O1 ; CCCCCCCCCCCCCC1CCC(=O)O1 ; CCCCCCCC1CCCC(=O)O1 ; CCCCCCCC1CCC(=O)O1]

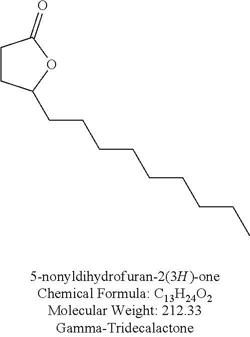

26. The method according to clause 1 wherein the one or more compounds represented by structure (A) are selected from the group consisting of methyl jasmonate, methyl dihydrojasmonate, methyl dihydrojasmolate (methyl 2-(3-hydroxy-2-pentylcyclopentyl)acetate), ethyl dihydrojasmonate, and propyl dihydrojasmonate.

27. The method according to clause 1 wherein the one or more compounds represented by structure (A) are selected from the group consisting of apritone (cyclopentanone, 2-(3,7-dimethyl-2,6-octadienyl)-), and methyl apritone (cyclopentanone, 2-(3,7-dimethyl-2,6-nonadien-1-yl)-).

28. The method according to clause 1 wherein the one or more compounds represented by structure (A) are selected from the group consisting of delta-dodecalactone, gamma-dodecalactone, gamma-undecalactone, gamma methyl dodecalactone, gamma-tridecalactone, gamma methyl tridecalactone, and gamma-tetradecalactone.

29. The method according to clause 1 wherein the one or more compounds represented by structure (A) are selected from the group consisting of 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, and 3-methyl-5-heptyl-2-cyclohexenone.

30. The method according to clause 1 wherein the composition further comprises at least one adjuvant or additive selected from a group consisting of a carrier, wetting agents, adjuvants, emulsifiers, dispersants, spreaders, stickers, pastes, anchorage agents, fixatives, extenders, coating agents, buffering agents, pH adjusters, plant nutrients, absorptive additives, disintegrants, and combinations thereof.

31. The method according to clause 1 wherein the composition comprises a liquid medium, wherein the liquid medium comprises the one or more compounds represented by the structure (A).

32. The method according to clause 31 wherein the liquid medium includes a surfactant.

33. The method according to clause 31 wherein the surfactant is an ionic, non-ionic, or zwitterionic surfactant.

34. The method according to clause 31 wherein the liquid medium includes an alcohol.

35. The method according to clause 31 wherein the liquid medium includes an oil.

36. The method according to clause 31 wherein the liquid medium includes a fixative selected from the group consisting of canola oil, castor oil, benzoyl benzoate, benzyl salicylate, synthetic musk, sandalwood, carnauba wax, carob gum, dextrin, dextrose, gellan gum, guar gum, paraffin wax, sorbitol, xanthan gum, polyvinylpyrrolidone, and glycerin.

37. The method according to clause 31 wherein the liquid medium includes an absorptive additive selected from the group consisting of silica gel; precipitated crystalline-free silica gel; amorphous, fumed, crystalline-free silica; amorphous, precipitated gel silica; silica hydrate; vitreous silica; silicic acid; and silicon dioxide.

38. The method according to clause 1 wherein the composition is applied to the plant or seed by a method selected from a group consisting of foliar application, soil application, seed treatment, injection onto plant tissues, and combinations thereof.

39. The method according to clause 1 wherein the method comprises applying the composition to the plant or seed by foliar application, said foliar application comprises applying the composition at a rate of 50-1000 ml/acre of crop such that the amount of the one or more compounds represented by structure (A) applied is about 0.125 g/m² to about 150 g/m².

40. The method according to clause 1 wherein the composition is applied to plant seeds, to germinating seedling roots before they are planted, or to roots of existing plants.

41. The method according to clause 1 wherein the composition is applied onto the seeds and plants after harvest and at storage.

42. The method according to clause 1 wherein the composition is applied in situ, in the course of transfer, or introduced onto the bases of target plants.

43. The method according to clause 1 wherein the composition is applied to plants or seeds to induce tolerance in the plants or seeds to biotic and abiotic stresses.

44. The method according to clause 1 wherein the composition is applied to plants or seeds to induce tolerance in the plants or seeds to biotic stresses caused by bacteria, fungus, oomycetes, viruses, or insects.

45. The method according to clause 1 wherein the composition is applied to plants or seeds to induce tolerance in the plants or seeds to abiotic stresses caused by low temperature/cold stress, freezing stress, high temperature/heat stress, salt/salinity stress, low light (shading stress), excessive light, ultraviolet (UV) radiation, other cosmic radiation, oxidative stress, heavy metal stress, lack of oxygen conditions, flooding, drought/water deficit, and/or a combination thereof.

46. The method according to clause 1 wherein application of the composition to target plants or seeds results in localized or systemic biotic or abiotic stress tolerance throughout the plant or seed.

47. The method according to clause 1 wherein application of the composition to target plants or seeds results in localized or systemic biotic or abiotic stress tolerance throughout the plant or seed during growth season or post-harvest.

48. The method according to clause 1 wherein the protective response in the seed improves seed germination and seedling growth by altering seed vigor and/or the physiological state of the seed.

49. A method of inducing tolerance in a plant or seed to an environmental stress, said method comprising applying to at least a portion of said plant or seed a composition comprising one or more compounds represented by structure (A):

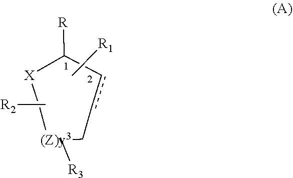

wherein R, X, Z, y, R₁, R₂, and R₃ are as defined in clause 1;
wherein the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds represented by structure (A);
wherein the one or more compounds represented by structure (A) are present in the composition in an effective amount sufficient to induce tolerance in the plant or seed to the environmental stress; and
wherein, when the method is for inducing tolerance in a seed to an environmental stress, the one or more compounds represented by structure (A) are other than a jasmonate.

50. An environmental stress-tolerant plant or seed produced by the method of clause 1.

51. A composition for protecting a plant or seed from stress injury resulting from an environmental stress, said composition comprising one or more compounds represented by structure (A):

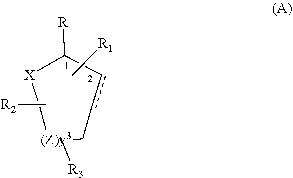

wherein:
   R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
   X is O or CH₂, with the proviso that when X is O, R can only be ═O; each Z is independently selected from (CH) and (CH₂);
   y is a numeral selected from 1 and 2;
   R₁ is selected from H or a branched or straight chain, saturated or unsaturated, hydrocarbyl group with zero to two double bonds and from about 1 to about 15 carbon atoms;
   R₂ is selected from H and a branched or straight chain, saturated or unsaturated, hydrocarbyl group with zero to three double bonds and from about 1 to about 15 carbon atoms;
   R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
   the bond between the 2 and 3 positions in the ring structure may be a single or a double bond;
   wherein the one or more compounds represented by structure (A) contain from about 9 to about 20 carbon atoms, and includes optical isomers, diastereomers and enantiomers of the two or more compounds of structure (A);
   wherein the one or more compounds represented by structure (A) are present in the composition in a protective amount sufficient to elicit a protective response in the plant or seed to the environmental stress; and
   wherein, when the composition is for protecting a seed from stress injury resulting from an environmental stress, the one or more compounds represented by structure (A) are other than a jasmonate.

52. The composition of clause 51 wherein the one or more compounds represented by structure (A) are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

53. The composition of clause 51 wherein the environmental stress is a biotic stress or an abiotic stress.

54. The composition of clause 53 wherein the biotic stress is induced by a living organism selected from the group consisting of a virus, bacteria, fungi, viroid, phytoplasma, nematode, insect, pathogen, arachnid, and weed.

55. The composition of clause 53 wherein the abiotic stress is selected from the group consisting of desiccation, salt, drought, osmotic, temperature, wind, water, light, heavy metals, cold, heat, ozone, ultraviolet (UV) radiation, and nutrient deficiency.

56. The composition of clause 51 wherein the stress injury comprises plant death, leaf yellowing, leaf death, no shoot meristem growth, poor shoot meristem growth, plant wilting, loss or degradation of chlorophyll in leaves, leaf browning, leaf wilting or curling, destruction of chloroplasts, leaf lesions, seed death, retarded seed germination, no seed germination, retarded growth (root and shoot) seedlings, no growth (root and shoot) seedlings, retarded rate of seed germination, lower root and shoot fresh weight, and/or reduced seedling vigor.

57. The composition of clause 51 wherein the plant or seed is selected from the group consisting of food crops, forage crops, fiber crops, oil crops, ornamental crops, and industrial crops.

58. The composition of clause 57 wherein the food crops are selected from the group consisting of cereals, fruits, vegetables, and spices.

59. The composition of clause 58 wherein the cereals are selected from the group consisting of wheat, rice, barley, millet, oats, rye, maize, sorghum; the fruits are selected from the group consisting of apples, pears, citrus, stone fruits, tropical fruits, exotic fruits, and berries; the vegetables are selected from the group consisting of root vegetables including beets, carrots, sweet potatoes, turnips; tubers: potatoes, yams; stem vegetables including asparagus, kohlrabi, celery; leafy green vegetables including lettuce, spinach, and silverbeet; allium or bulb vegetables including garlic, leeks, onions, and shallots; head or flower vegetables including artichokes, cabbage, and cauliflower; cucumber family vegetables including pumpkin, cucumber, and zucchini; and spices including pepper, ginger, spice seeds, and herbs.

60. The composition of clause 57 wherein the forage crops are selected from the group consisting of sorghum, alfalfa, barley, oats, millet, soybeans, wheat, maize, hay, and silage.

61. The composition of clause 57 wherein the fiber crops are selected from the group consisting of cotton, hemp, jute, kenaf, and flax.

62. The composition of clause 57 wherein the oil crops are selected from the group consisting of soybeans, sunflower seeds, rapeseed, canola, carmelina, palm, and peanuts.

63. The composition of clause 57 wherein the ornamental crops are selected from the group consisting of ivy, oleander, holly, tulips, roses, and azaleas.

64. The composition of clause 57 wherein the industrial crops are selected from the group consisting of cotton, jute, sugarcane, sugarbeet, coffee, tea, tobacco, coconut, and soybeans.

65. The composition of clause 57 wherein the seeds are selected from the group consisting of cereals, nuts, legumes, and spices.

66. The composition of clause 51 wherein the plant is a root, a stem, a leaf, a seed, a flower, or part thereof.

67. The composition of clause 51 wherein the plant is a dicot, monocot, annual, perennial, crop plant, alfalfa, rice, wheat, barley, rye, cotton, sunflower, peanut, corn, oat, millet, flax, potato, sweet potato, bean, green bean, wax bean, lima bean, pea, chicory, lettuce, endive, cabbage, brussel sprout, beet, sugar beet, parsnip, turnip, cauliflower, broccoli, turnip, radish, spinach, onion, garlic, eggplant, pepper, celery, carrot, squash, pumpkin, zucchini, cucumber, melon, yam, carrots, cassava, citrus, strawberry, grape, raspberry, pineapple, soybean, tobacco, tomato, sorghum, sugarcane, ornamental plant, Arabidopsis thaliana, Saintpaulia, petunia, pelargonium, poinsettia, chrysanthemum, carnation, zinnia, poplar, apple, pear, peach, cherry, almond, plum, hazelnuts, banana, apricot, grape, kiwi, mango, melon, papaya, walnut, pistachio, raspberry, blackberry, loganberry, blueberry, cranberry, orange, lemon, grapefruit, tangerine, avocado, or cocoa.

68. The composition of clause 51 wherein the one or more compounds represented by structure (A) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

69. The composition of clause 51 wherein the one or more compounds represented by structure (A) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is-C(O) OR₅, and R₅ is an alkyl or alkenyl group containing at least 3 carbon atoms.

70. The composition of clause 51 wherein the one or more compounds represented by structure (A) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

71. The composition of clause 51 wherein the one or more compounds represented by structure (A) are selected from the group consisting of:

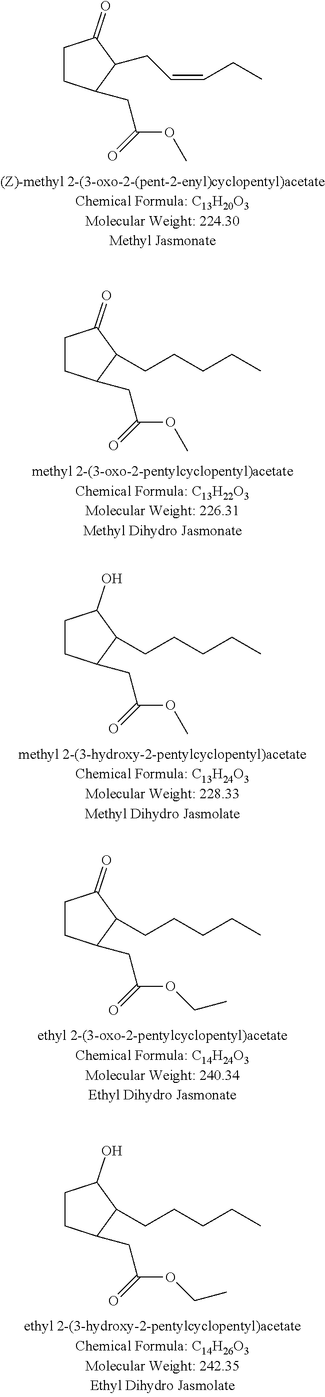 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC ; CCCCCC1C(O)CCC1CC(=O)OCC]

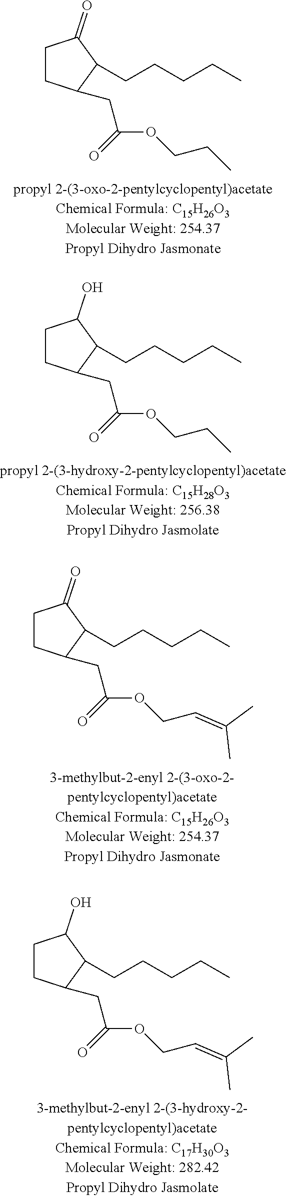 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

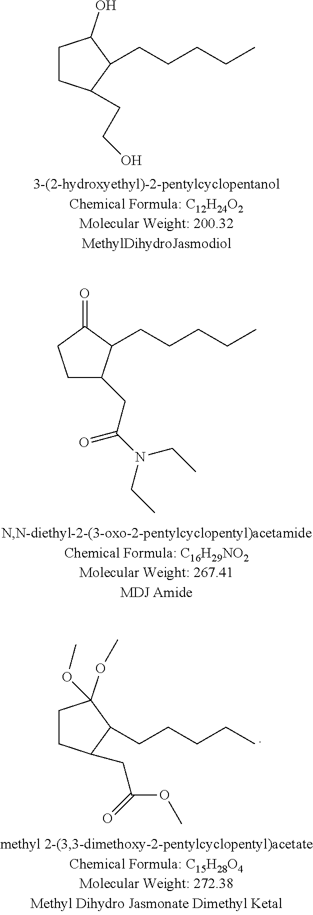 [SMILES: CCCCCC1C(O)CCC1CCO ; CCCCCC1C(=O)CCC1CC(=O)N(CC)CC ; CCCCCC1C(CC(=O)OC)CCC1(OC)OC]

72. The composition of clause 51 wherein the one or more compounds represented by structure (A) are selected from the group consisting of:

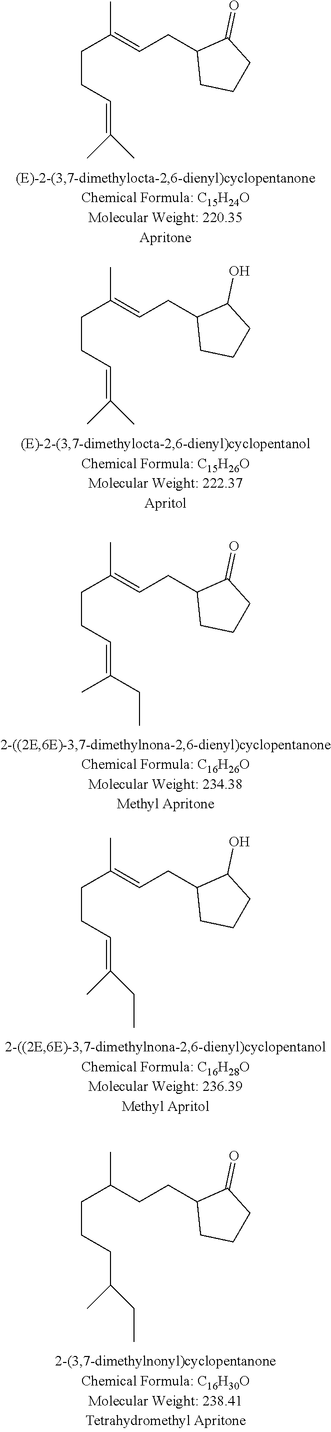 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O]

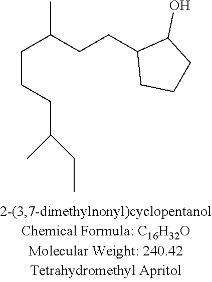 [SMILES: CCC(C)CCCC(C)CCC1CCCC1O]

73. The composition of clause 51 wherein the one or more compounds represented by structure (A) are selected from the group consisting of:

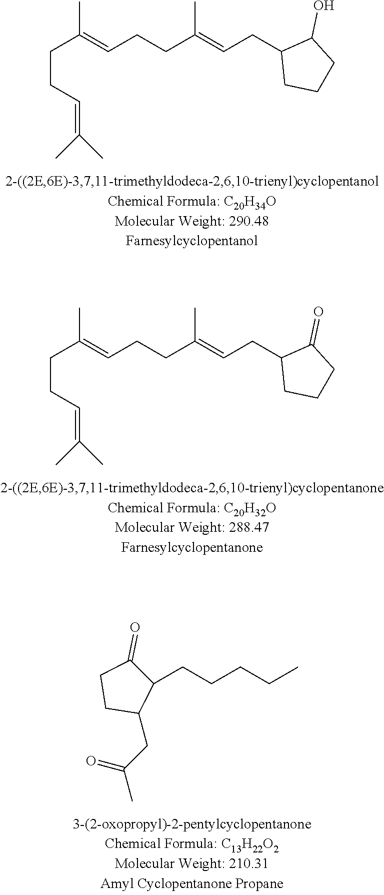 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O]

74. The composition of clause 51 wherein the one or more compounds represented by structure (A) are selected from the group consisting of:

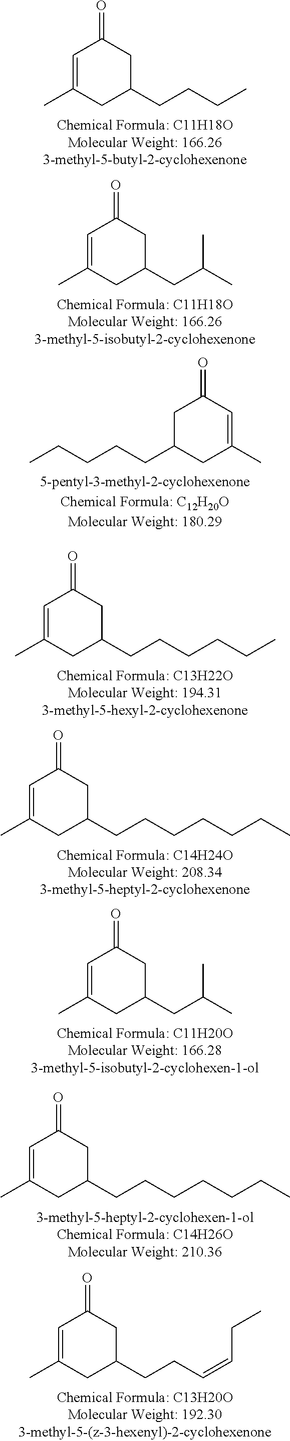

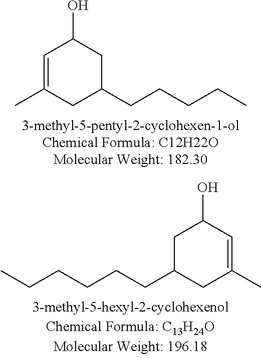

75. The composition of clause 51 wherein the one or more compounds represented by structure (A) are selected from the group consisting of:

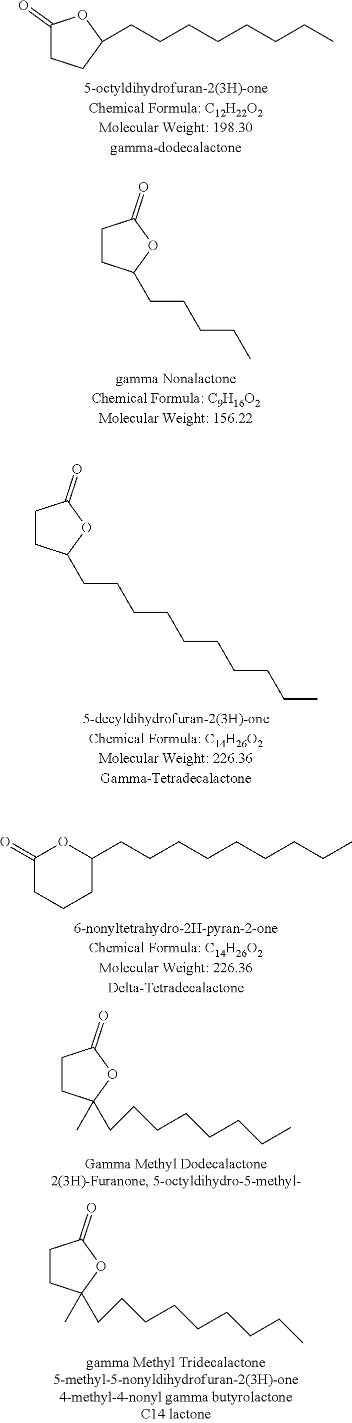 [SMILES: CCCCCCCCC1CCC(=O)O1 ; CCCCCC1CCC(=O)O1 ; CCCCCCCCCCC1CCC(=O)O1 ; CCCCCCCCCC1CCCC(=O)O1 ; CCCCCCCCC1(C)CCC(=O)O1 ; CCCCCCCCCC1(C)CCC(=O)O1]

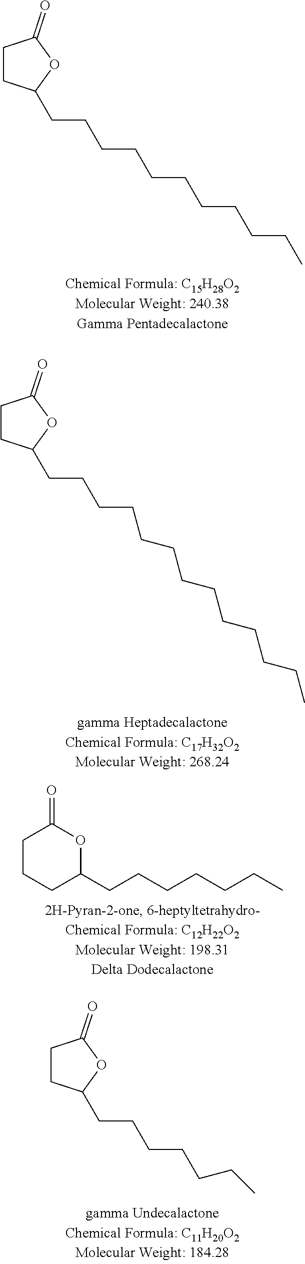 [SMILES: CCCCCCCCCCCC1CCC(=O)O1 ; CCCCCCCCCCCCCC1CCC(=O)O1 ; CCCCCCCC1CCCC(=O)O1 ; CCCCCCCC1CCC(=O)O1]

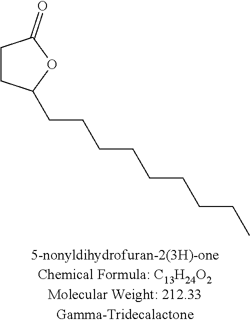

76. The composition of clause 51 wherein the one or more compounds represented by structure (A) are selected from the group consisting of methyl jasmonate, methyl dihydrojasmonate, methyl dihydrojasmolate (methyl 2-(3-hydroxy-2-pentylcyclopentyl)acetate), ethyl dihydrojasmonate, and propyl dihydrojasmonate.

77. The composition of clause 51 wherein the one or more compounds represented by structure (A) are selected from the group consisting of apritone (cyclopentanone, 2-(3,7-dimethyl-2,6-octadienyl)-), and methyl apritone (cyclopentanone, 2-(3,7-dimethyl-2,6-nonadien-1-yl)-).

78. The composition of clause 51 wherein the one or more compounds represented by structure (A) are selected from the group consisting of delta-dodecalactone, gamma-dodecalactone, gamma-undecalactone, gamma methyl dodecalactone, gamma-tridecalactone, gamma methyl tridecalactone, and gamma-tetradecalactone.

79. The composition of clause 51 wherein the one or more compounds represented by structure (A) are selected from the group consisting of 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, and 3-methyl-5-heptyl-2-cyclohexenone.

80. The composition of clause 51 further comprising at least one adjuvant or additive selected from a group consisting of a carrier, wetting agents, adjuvants, emulsifiers, dispersants, spreaders, stickers, pastes, anchorage agents, fixatives, extenders, coating agents, buffering agents, pH adjusters, plant nutrients, absorptive additives, disintegrants, and combinations thereof.

81. The composition of clause 51 further comprising a liquid medium, wherein the liquid medium comprises the one or more compounds represented by the structure (A).

82. The composition of clause 81 wherein the liquid medium includes a surfactant.

83. The composition of clause 82 wherein the surfactant is an ionic, non-ionic, or zwitterionic surfactant.

84. The composition of clause 81 wherein the liquid medium includes an alcohol.

85. The composition of clause 51 wherein the liquid medium includes an oil.

86. The composition of clause 81 wherein the liquid medium includes a fixative selected from the group consisting of canola oil, castor oil, benzoyl benzoate, benzyl salicylate, synthetic musk, sandalwood, carnauba wax, carob gum, dextrin, dextrose, gellan gum, guar gum, paraffin wax, sorbitol, xanthan gum, polyvinylpyrrolidone, and glycerin.

87. The composition of clause 51 wherein the liquid medium includes an absorptive additive selected from the group consisting of silica gel; precipitated crystalline-free silica gel; amorphous, fumed, crystalline-free silica; amorphous, precipitated gel silica; silica hydrate; vitreous silica; silicic acid; and silicon dioxide.

88. The composition of clause 51 which is applied to the plant or seed by a method selected from a group consisting of foliar application, soil application, seed treatment, injection onto plant tissues, and combinations thereof.

89. The composition of clause 51 which is applied to the plant or seed by foliar application, said foliar application comprises applying the composition at a rate of 50-1000 ml/acre of crop such that the amount of the one or more compounds represented by structure (A) applied is about 0.125 g/m² to about 150 g/m².

90. The composition of clause 51 which is applied to plant seeds, to germinating seedling roots before they are planted, or to roots of existing plants.

91. The composition of clause 51 which is applied onto the seeds and plants after harvest and at storage.

92. The composition of clause 51 which is applied in situ, in the course of transfer, or introduced onto the bases of target plants.

93. The composition of clause 51 which is applied to plants or seeds to induce tolerance in the plants or seeds to biotic and abiotic stresses.

94. The composition of clause 51 which is applied to plants or seeds to induce tolerance in the plants or seeds to biotic stresses caused by bacteria, fungus, oomycetes, viruses, or insects.

95. The composition of clause 51 which is applied to plants or seeds to induce tolerance in the plants or seeds to abiotic stresses caused by low temperature/cold stress, freezing stress, high temperature/heat stress, salt/salinity stress, low light (shading stress), excessive light, ultraviolet (UV) radiation, other cosmic radiation, oxidative stress, heavy metal stress, lack of oxygen conditions, flooding, drought/water deficit, and/or a combination thereof.

96. The composition of clause 51 wherein application of the composition to target plants or seeds results in localized or systemic biotic or abiotic stress tolerance throughout the plant or seed.

97. The composition of clause 51 wherein application of the composition to target plants or seeds results in localized or systemic biotic or abiotic stress tolerance throughout the plant or seed during growth season or post-harvest.

98. The composition of clause 51 wherein the protective response in the seed improves seed germination and seedling growth by altering seed vigor and/or the physiological state of the seed.

99. A composition for inducing tolerance in a plant or seed to an environmental stress, said composition comprising one or more compounds represented by structure (A):

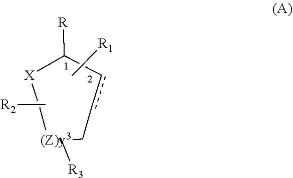

wherein R, X, Z, y, R₁, R₂, and R₃ are as defined in clause 51;
wherein the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the two or more compounds of structure (A);
wherein the one or more compounds represented by structure (A) are present in the composition in an effective amount sufficient to induce tolerance in the plant or seed to the environmental stress; and
wherein, when the composition is for inducing tolerance in a seed to an environmental stress, the one or more compounds represented by structure (A) are other than a jasmonate.

100. An environmental stress-tolerant plant or seed treated with the composition of clause 51.

101. A method of protecting a plant or seed from stress injury resulting from an environmental stress, said method comprising applying to at least a portion of said plant or seed a synergistic composition comprising a synergistic combination of two or more compounds represented by structure (A):

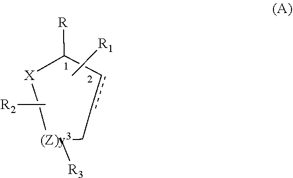

wherein R, X, Z, y, R₁, R₂, and R₃ are as defined in clause 1;
wherein the bond between the 2 and 3 positions in the ring structure may be a single or a double bond;
wherein the two or more compounds of structure (A) contain from about 9 to about 20 carbon atoms, and includes optical isomers, diastereomers and enantiomers of the two or more compounds of structure (A);
wherein the two or more compounds of structure (A) are present in the synergistic composition in a protective amount sufficient to elicit a protective response in the plant or seed to the environmental stress; and
wherein the synergistic combination comprising a combination of two or more compounds of structure (A) produces, when the plant or seed is treated with the synergistic composition, a combined protection effect, greater than the sum of the separate protection effects, at essentially the same concentrations.

102. A synergistic composition for protecting a plant or seed from stress injury resulting from an environmental stress, said synergistic composition comprising a synergistic combination of two or more compounds represented by structure (A):

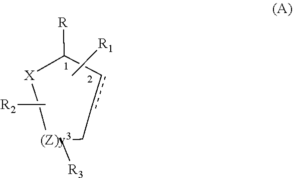

wherein R, X, Z, y, R₁, R₂, and R₃ are as defined in clause 51;
wherein the bond between the 2 and 3 positions in the ring structure may be a single or a double bond;
wherein the two or more compounds of structure (A) contain from about 9 to about 20 carbon atoms, and includes optical isomers, diastereomers and enantiomers of the two or more compounds of structure (A);
wherein the two or more compounds of structure (A) are present in the synergistic composition in a protective amount sufficient to elicit a protective response in the plant or seed to the environmental stress; and
wherein the synergistic combination comprising a combination of two or more compounds of structure (A) produces, when the plant or seed is treated with the synergistic composition, a combined protection effect, greater than the sum of the separate protection effects, at essentially the same concentrations.

103. A method for inducing tolerance in a plant or seed to an environmental stress, said method comprising applying to at least a portion of said plant or seed a synergistic composition comprising a synergistic combination of two or more compounds represented by structure (A):

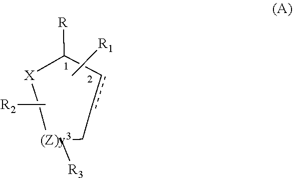

wherein R, X, Z, y, R₁, R₂, and R₃ are as defined in clause 1;
wherein the bond between the 2 and 3 positions in the ring structure may be a single or a double bond;
wherein the two or more compounds of structure (A) contain from about 9 to about 20 carbon atoms, and includes optical isomers, diastereomers and enantiomers of the two or more compounds of structure (A);
wherein the two or more compounds of structure (A) are present in the synergistic composition in an effective amount sufficient to induce tolerance in the plant or seed to the environmental stress; and
wherein the synergistic combination comprising a combination of two or more compounds of structure (A) produces, when the plant or seed is treated with the synergistic composition, a combined protection effect, greater than the sum of the separate protection effects, at essentially the same concentrations.

104. A synergistic composition for inducing tolerance in a plant or seed to an environmental stress, said synergistic composition comprising a synergistic combination of two or more compounds represented by structure (A):

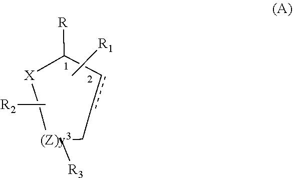

wherein R, X, Z, y, R₁, R₂, and R₃ are as defined in clause 51;
wherein the bond between the 2 and 3 positions in the ring structure may be a single or a double bond;
wherein the two or more compounds of structure (A) contain from about 9 to about 20 carbon atoms, and includes optical isomers, diastereomers and enantiomers of the two or more compounds of structure (A);
wherein the two or more compounds of structure (A) are present in the synergistic composition in an effective amount sufficient to induce tolerance in the plant or seed to the environmental stress; and
wherein the synergistic combination comprising a combination of two or more compounds of structure (A) produces, when the plant or seed is treated with the synergistic composition, a combined protection effect, greater than the sum of the separate protection effects, at essentially the same concentrations.

105. The synergistic composition of clause 102, wherein the protection effect is reduced application rate, widening of the activity spectrum, increase in the activity of the substances and compositions to be used, better plant growth, increased tolerance to high or low temperatures, increased tolerance to drought or to water or soil salt content, increased flowering performance, easier harvesting, accelerated maturation, higher harvest yields, better quality of the harvested products, higher nutritional value of the harvested products, better storage stability of the harvested products, or processability of the harvested products.

106. The synergistic composition of clause 104, wherein the induced tolerance is increased tolerance to high or low temperatures, or increased tolerance to drought or to water or soil salt content.

107. A method of seed treatment, said method comprising applying to at least a portion of said seed a composition comprising one or more compounds represented by structure (A):

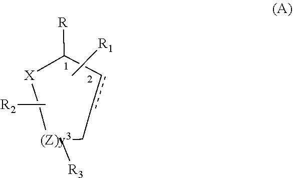

wherein:
   R is selected from —OH, —O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
   X is O or CH₂, with the proviso that when X is O, R can only be ═O;
   each Z is independently selected from (CH) and (CH₂);
   y is a numeral selected from 1 and 2;
   R₁ is selected from H or a branched or straight chain, saturated or unsaturated, hydrocarbyl group with zero to two double bonds and from about 1 to about 15 carbon atoms;
   R₂ is selected from H and a branched or straight chain, saturated or unsaturated, hydrocarbyl group with zero to three double bonds and from about 1 to about 15 carbon atoms;
   R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
   the bond between the 2 and 3 positions in the ring structure may be a single or a double bond;
   wherein the one or more compounds represented by structure (A) contain from about 9 to about 20 carbon atoms, and includes optical isomers, diastereomers and enantiomers of the one or more compounds represented by structure (A);
   wherein the one or more compounds represented by structure (A) are present in the composition in an effective amount sufficient to improve a germination characteristic of the seed, as compared to the same germination characteristic of an untreated seed; and
   wherein the one or more compounds represented by structure (A) are other than a jasmonate.

108. The method of clause 107, wherein the germination characteristic of the seed is germination rate, rate of development, vigor, or yield of mature plants originating from the seed.

109. A seed treated by the method of claim 107.

110. A method of seed treatment, said method comprising applying to at least a portion of said seed a synergistic composition comprising a synergistic combination of two or more compounds represented by structure (A):

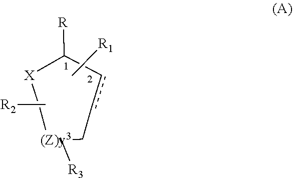

wherein:
   R is selected from —OH, —O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
   X is O or CH₂, with the proviso that when X is O, R can only be ═O;
   each Z is independently selected from (CH) and (CH₂);
   y is a numeral selected from 1 and 2;
   R₁ is selected from H or a branched or straight chain, saturated or unsaturated, hydrocarbyl group with zero to two double bonds and from about 1 to about 15 carbon atoms;
   R₂ is selected from H and a branched or straight chain, saturated or unsaturated, hydrocarbyl group with zero to three double bonds and from about 1 to about 15 carbon atoms;
   R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
   the bond between the 2 and 3 positions in the ring structure may be a single or a double bond;
   wherein the two or more compounds of structure (A) contain from about 9 to about 20 carbon atoms, and includes optical isomers, diastereomers and enantiomers of the two or more compounds of structure (A);
   wherein the two or more compounds of structure (A) are present in the synergistic composition in an amount sufficient to effect a germination characteristic of the seed; and
   wherein the synergistic combination comprising a combination of two or more compounds of structure (A) produces, when the seed is treated with the synergistic composition, a combined germination characteristic effect, greater than the sum of the separate germination characteristic effects, at essentially the same concentrations.

111. The method of clause 110, wherein the germination characteristic of the seed is germination rate, rate of development, vigor, or yield of mature plants originating from the seed.

112. A seed treated by the method of clause 110.

113. A synergistic composition for improving a germination characteristic of a seed, said synergistic composition comprising a synergistic combination of two or more compounds represented by structure (A):

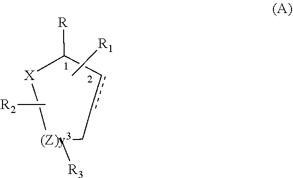

wherein:
   R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
   X is O or CH₂, with the proviso that when X is O, R can only be ═O;
   each Z is independently selected from (CH) and (CH₂);
   y is a numeral selected from 1 and 2;
   R₁ is selected from H or a branched or straight chain, saturated or unsaturated, hydrocarbyl group with zero to two double bonds and from about 1 to about 15 carbon atoms;
   R₂ is selected from H and a branched or straight chain, saturated or unsaturated, hydrocarbyl group with zero to three double bonds and from about 1 to about 15 carbon atoms;
   R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
   the bond between the 2 and 3 positions in the ring structure may be a single or a double bond;
   wherein the two or more compounds of structure (A) contain from about 9 to about 20 carbon atoms, and includes optical isomers, diastereomers and enantiomers of the two or more compounds of structure (A);
   wherein the two or more compounds of structure (A) are present in the synergistic composition in an amount sufficient to effect a germination characteristic of the seed; and
   wherein the synergistic combination comprising a combination of two or more compounds of structure (A) produces, when the seed is treated with the synergistic composition, a combined germination characteristic effect, greater than the sum of the separate germination characteristic effects, at essentially the same concentrations.

114. The synergistic composition of clause 113, wherein the germination characteristic of the seed is germination rate, rate of development, vigor, or yield of mature plants originating from the seed.

115. A seed treated by the synergistic composition of clause 113.

As used herein, the term “about” is defined as plus or minus ten percent of a recited value. For example, about 1.0 g means 0.9 g to 1.1 g. Alternatively, depending on context, the term “about” can be defined as plus or minus of up to fifty percent of a recited value. For example, about 1.0 g means up to between 0.5 g to 1.5 g.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

Embodiments of the present disclosure are shown and described herein. It will be apparent to those skilled in the art that such embodiments are provided by way of example only. Numerous variations, changes, and substitutions will occur to those skilled in the art without departing from the disclosure. Various alternatives to the embodiments of the disclosure described herein may be employed in practicing the disclosure. It is intended that the included claims define the scope of the disclosure and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

### Example 1

### Reduction of Salt Stress on Biomass

Fifteen Capsicum annum ‘Pepperoncini’ pepper plants in 4″ pots were divided into 3 treatment groups of five plants per treatment (n=5): T1: untreated, 0.1% ethanol in water as the control, T2: treated, 2.0 mM methyl dihydrojasmonate (MDJ) in 0.1% ethanol and T3: treated, 2.0 mM methyl dihydrojasmonate (MDJ) in 0.1% ethanol plus 100 mM of NaCl (sodium chloride, common salt). Plants at the beginning of the experiment were fairly uniform in size, ranging from 13-18 cm. in height from soil level to the apical meristem. Plants were treated with the 0.1% ethanol plus MDJ solution (T2) by pouring on roots until water ran through the bottom of the pot (150 ml), and by spraying leaves until the point of drip. Plants were treated with the sodium chloride solution by pouring on roots until the point of running through the bottom of the pot (150 ml). For each subsequent watering, the salt-treated plants received the 100 mM NaCl treatment while the non-salt treated plants received tap water. Plants were treated a second time with 0.1% ethanol in water or 2 mM MDJ in 0.1% ethanol on day 5 of the experiment. Plants were treated with a liquid, root fertilizer on day 13 of the experiment. Total dry weight and root mass was calculated at the end of the experiment on Day 31. Before the dry weights were taken, the number of buds and blooms were counted on each plant.

This experiment was primarily concerned with evaluating the effect of MDJ on causing an increase or decrease in biomass in salt stressed plants. Thirty-one days after the first treatment and the dry weight of the above-ground plant tissues and below-ground root tissues were recorded. Table 1 shows the average of total dry mass of plants (leaves, stems, reproductive tissues & roots) for T1: untreated, 0.1% ethanol in water as the control, T2: treated, 2.0 mM MDJ in 0.1% ethanol and T3: treated, 2.0 mM MDJ in 0.1% ethanol plus 100 mM of NaCl (sodium chloride, common salt). Compared to the control plants in Treatment 1 that received ethanol alone, plants receiving MDJ in ethanol in Treatments 2 and 3 had increased total dry weight (see Table 1 below). Furthermore, the data indicates that the combination of salt plus MDJ further increased total plant mass compared to MDJ treatment alone. Compared to the Control treatment, plants receiving MDJ+salt had a 47.7% increase in dry mass.

TABLE 1
Results of Example 1

| | Total | % Change |
|---|---|---|
| | Dry mass | (increment) |
| Treatment | (g) | w/treatment |
| T1: untreated, 0.1% ethanol | 4.4 +/− 0.65 | — |
| in water, as the control | | |
| T2: treated, 2.0 mM | 5.7 +/− 0.38 | 29.50% |
| MDJ in 0.1% ethanol | | |
| T3: treated, 2.0 mM | 6.5 +/− 1.32 | 47.70% |
| MDJ in 0.1% ethanol | | |
| plus 100 mM of NaCl | | |

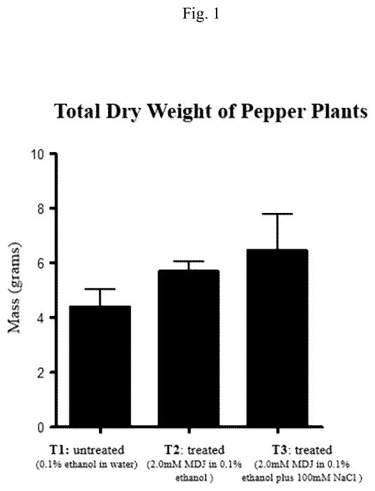

FIG. 1 graphically shows the average of total dry mass of plants (leaves, stems, reproductive tissues & roots) for T1: untreated, 0.1% ethanol in water as the control, T2: treated, 2.0 mM MDJ in 0.1% ethanol and T3: treated, 2.0 mM MDJ in 0.1% ethanol plus 100 mM of NaCl (sodium chloride, common salt), in accordance with Example 1.

### Example 2

### Reduction of Drought Stress

Greenhouse-grown miniature Parade® Roses of uniform size and developmental stage were watered for a final time just prior to receiving foliar treatments with T1: (untreated, water as control) or T2: (treated, 1.5 mM MDJ in water plus other inert ingredients). There were 12 plants per treatment. Plants were evaluated for visible symptoms of drought including effects on petals, peduncles (flower stem) and leaves following water restriction. The number of flowers per plant showing petal wilt or bowing of the peduncle of an angle greater than 45° were counted on days 1-5. The number of plants exhibiting leaf wilt were also counted for 5 days after treatment.

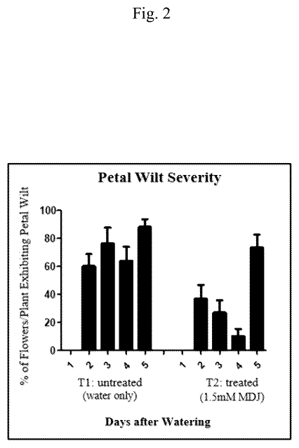

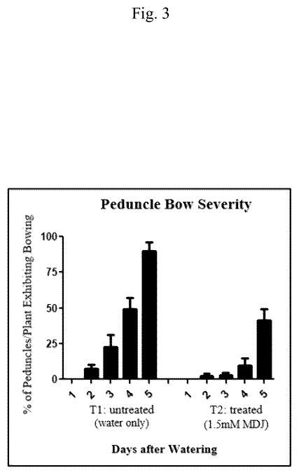

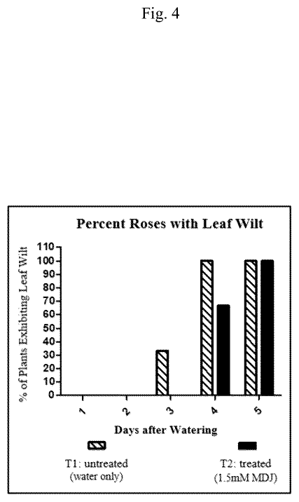

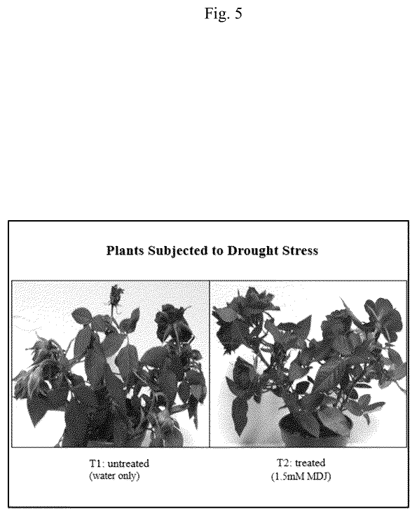

Compared to roses of group T1: (untreated, water as control), roses receiving T2: (treated, 1.5 mM MDJ in water plus other inert ingredients) exhibited delayed onset of drought symptoms in petals, peduncles and leaves (FIGS. 2, 3 and 4, respectively). Flower petal wilt was the first symptom of water shortage. FIG. 2 shows that MDJ-treated roses (T2) actually recovered from petal wilt on days 2-4 while control plants (T1) did not. This may be due to cooler conditions on days 2-4 than on day 1. The daytime high temperature on day 1 was 90° F. while temperatures on days 2-4 never reached above 75° F. FIGS. 3 and 4 show delayed onset of peduncle bending and leaf wilt. FIG. 5 shows a typical control (T1) and MDJ treated plant (T2) subjected to drought stress. While control plants (T1) have wilted petals and leaves and bent peduncles, MDJ treated plants (T2) maintained turgid petals, leaves and peduncles.

FIG. 2 graphically illustrates % of flowers/plant exhibiting petal wilt and petal wilt severity during 5 days of evaluation for T1: untreated, water as the control, and T2: treated, 1.5 mM MDJ in water plus other inert ingredients, in accordance with Example 2.

FIG. 3 graphically illustrates % of peduncles/plant exhibiting bowing and peduncle bow severity during 5 days of evaluation for T1: untreated, water as the control, and T2: treated, 1.5 mM MDJ in water plus other inert ingredients, in accordance with Example 2.

FIG. 4 graphically illustrates % of plants exhibiting leaf wilt during 5 days of evaluation for T1: untreated, water as the control, and T2: treated, 1.5 mM MDJ in water plus other inert ingredients, in accordance with Example 2.

FIG. 5 shows plants that were subjected to drought stress for T1: untreated, water as the control, and T2: treated, 1.5 mM MDJ in water plus other inert ingredients, in accordance with Example 2.

### Example 3

### Reduction of Drought Stress and Associated Leaf Yellowing

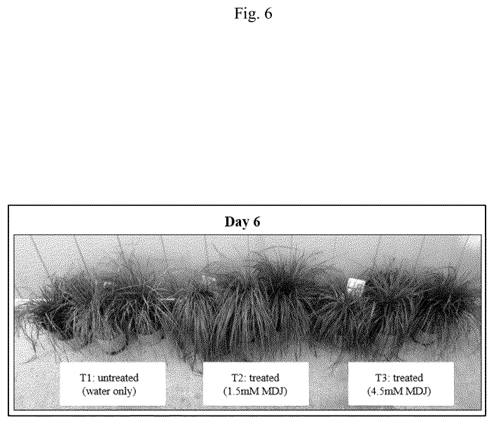

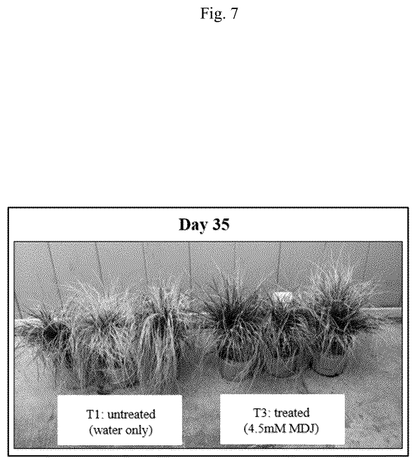

Tufted Hair Grass (Deschampsia ceaspitosa) was watered thoroughly from the bottom until soil was saturated. Plants (n=3) then received one application of water (T1: untreated, control), 1.5 mM MDJ in water (T2: treated), and 4.5 mM MDJ in water (T3: treated), as a soil soak and leaf application. Plants were left to dry out for 3 days until wilt was noted and then re-watered. Photos were taken 3 days later on Day 6 of the study (see FIG. 6). On Day 7, one spray treatment of the control (T1) and 4.5 mM MDJ (T3) plants occurred. Plants had sufficient water until photos were taken on Day 35 (see FIG. 7).

Compared to plants of group T1: (untreated, water as control) plants receiving T2: (treated, 1.5 mM MDJ in water) and T3 (treated, 4.5 mM MDJ in water) exhibited less leaf browning after 6 days. After the period of 35 days, T3 (treated, 4.5 mM MDJ in water) exhibited less leaf browning when compared to plants of T1 (untreated, water as control).

FIG. 6 shows plants that were subjected to drought stress after 6 days for T1: untreated, water as the control, T2: treated, 1.5 mM MDJ in water) and T3: (treated, 4.5 mM MDJ in water) in accordance with Example 3.

FIG. 7 shows plants that were subjected to drought stress after 35 days for T1: untreated, water as the control and T3: (treated, 4.5 mM MDJ in water) in accordance with Example 3.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method of protecting a plant or seed from stress injury resulting from an environmental stress, said method comprising applying to at least a portion of said plant or seed a composition comprising one or more compounds represented by structure (A): 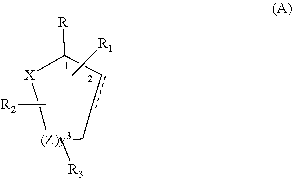
wherein:
R is selected from —OH, —O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds represented by structure (A);
wherein the one or more compounds represented by structure (A) are present in the composition in a protective amount sufficient to elicit a protective response in the plant or seed to the environmental stress; and
wherein, when the method is for protecting a seed from stress injury resulting from an environmental stress, the one or more compounds represented by structure (A) are other than a jasmonate.

2. The method of claim 1 wherein the one or more compounds represented by structure (A) are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

3. The method of claim 1 wherein the environmental stress is a biotic stress or an abiotic stress.

4. The method of claim 3 wherein the biotic stress is induced by a living organism selected from the group consisting of a virus, bacteria, fungi, viroid, phytoplasma, nematode, insect, pathogen, arachnid, and weed.

5. The method of claim 3 wherein the abiotic stress is selected from the group consisting of desiccation, salt, drought, osmotic, temperature, wind, water, light, heavy metals, cold, heat, ozone, ultraviolet (UV) radiation, and nutrient deficiency.

6. The method of claim 1 wherein the stress injury comprises plant death, leaf yellowing, leaf death, no shoot meristem growth, poor shoot meristem growth, plant wilting, loss or degradation of chlorophyll in leaves, leaf browning, leaf wilting or curling, destruction of chloroplasts, leaf lesions, seed death, retarded seed germination, no seed germination, retarded growth (root and shoot) seedlings, no growth (root and shoot) seedlings, retarded rate of seed germination, lower root and shoot fresh weight, and/or reduced seedling vigor.

7. The method of claim 1 wherein the plant or seed is selected from the group consisting of food crops, forage crops, fiber crops, oil crops, ornamental crops, and industrial crops.

8. The method of claim 7 wherein the food crops are selected from the group consisting of cereals, fruits, vegetables, and spices; the forage crops are selected from the group consisting of sorghum, alfalfa, barley, oats, millet, soybeans, wheat, maize, hay, and silage; the fiber crops are selected from the group consisting of cotton, hemp, jute, kenaf, and flax; the oil crops are selected from the group consisting of soybeans, sunflower seeds, rapeseed, canola, carmelina, palm, and peanuts; the ornamental crops are selected from the group consisting of ivy, oleander, holly, tulips, roses, and azaleas; and the industrial crops are selected from the group consisting of cotton, jute, sugarcane, sugarbeet, coffee, tea, tobacco, coconut, and soybeans.

9. The method of claim 7 wherein the seeds are selected from the group consisting of cereals, nuts, legumes, and spices.

10. The method of claim 1, wherein the plant is a root, a stem, a leaf, a seed, a flower, or part thereof.

11. The method according to claim 1 wherein the one or more compounds represented by structure (A) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds; or wherein the one or more compounds represented by structure (A) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms; or wherein the one or more compounds represented by structure (A) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

12. The method according to claim 1 wherein the one or more compounds represented by structure (A) are selected from the group consisting of:

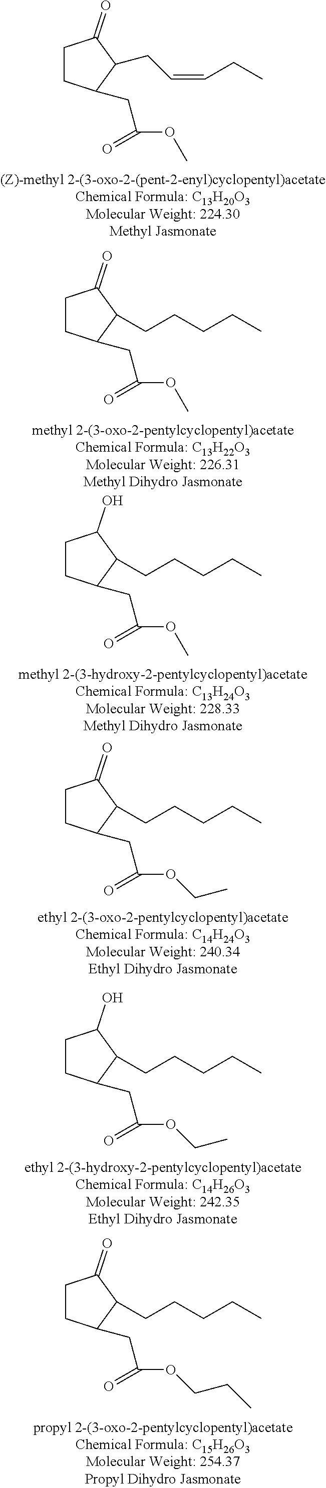 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC ; CCCCCC1C(O)CCC1CC(=O)OCC ; CCCCCC1C(=O)CCC1CC(=O)OCCC]

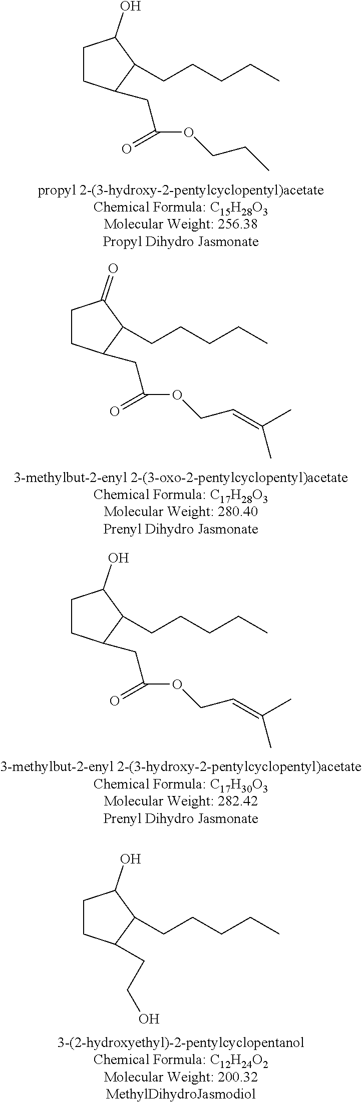 [SMILES: CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C ; CCCCCC1C(O)CCC1CCO]

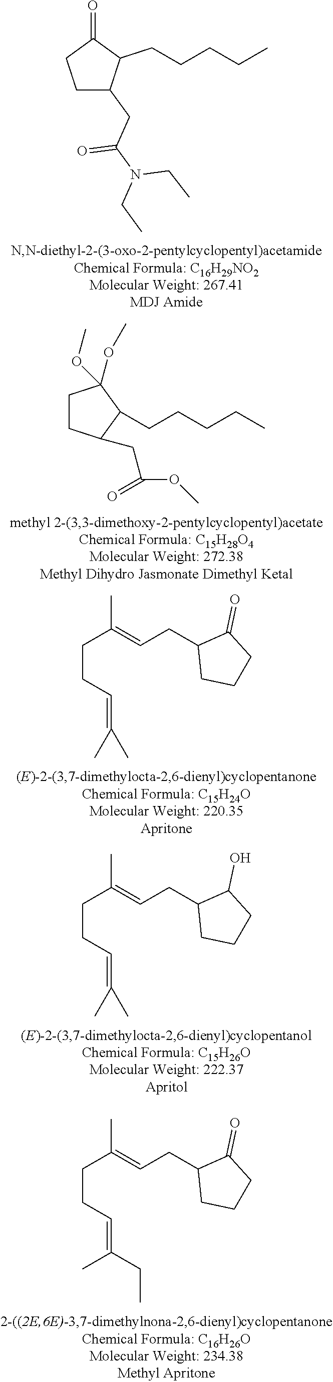 [SMILES: CCCCCC1C(=O)CCC1CC(=O)N(CC)CC ; CCCCCC1C(CC(=O)OC)CCC1(OC)OC ; CC(C)=CCC/C(C)=C/CC1CCCC1=O ; CC(C)=CCC/C(C)=C/CC1CCCC1O ; CC/C(C)=C/CC/C(C)=C/CC1CCCC1=O]

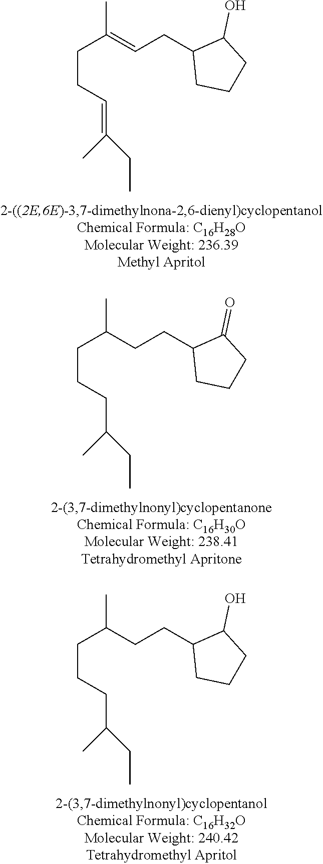 [SMILES: CC/C(C)=C/CC/C(C)=C/CC1CCCC1O ; CCC(C)CCCC(C)CCC1CCCC1=O ; CCC(C)CCCC(C)CCC1CCCC1O]

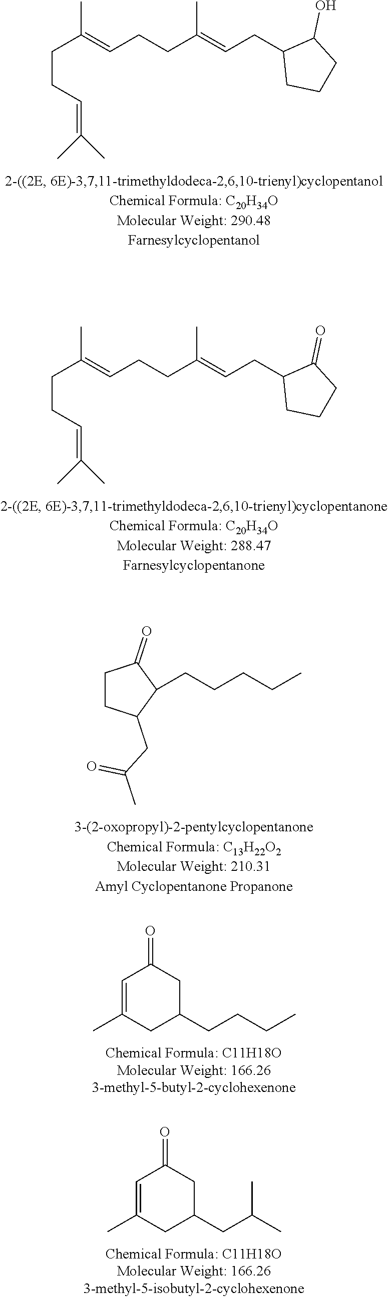

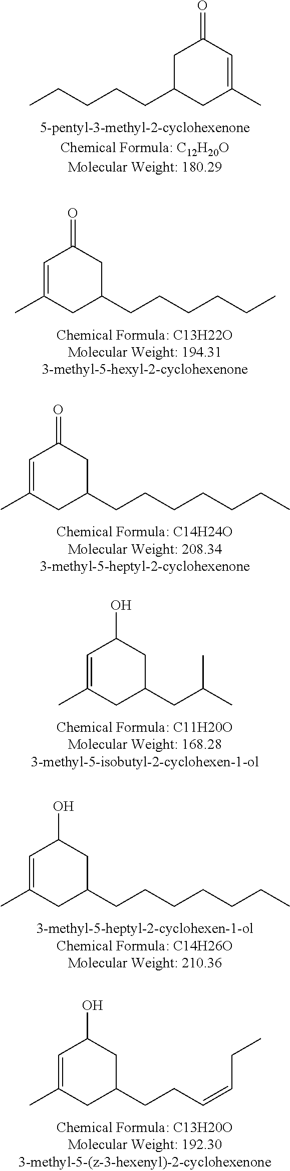

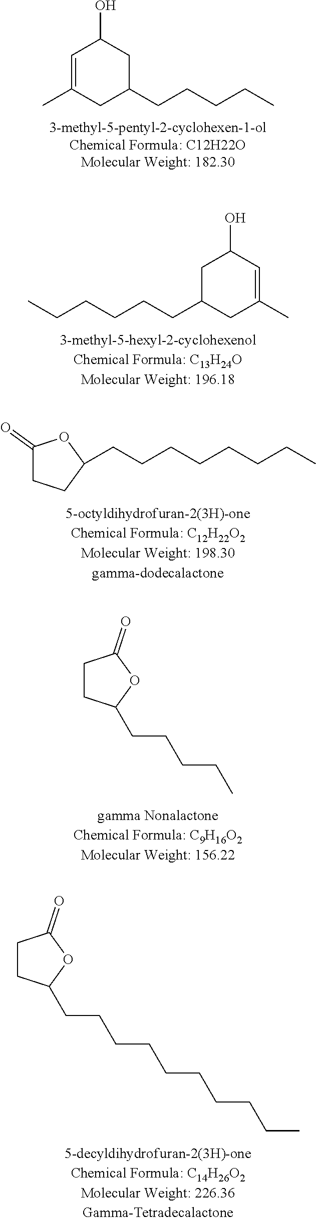

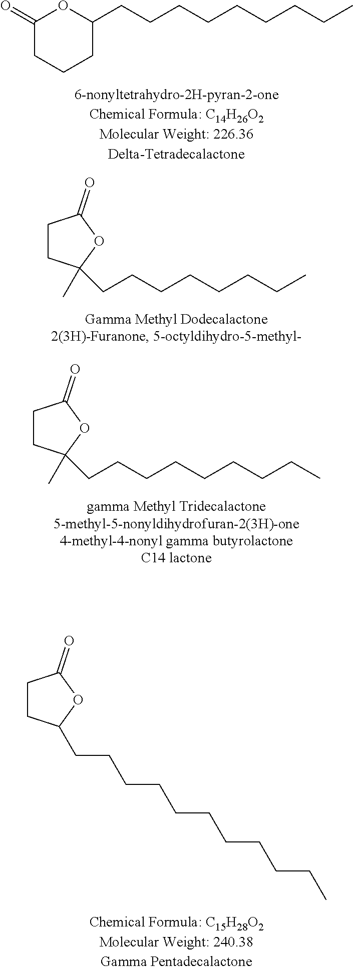 [SMILES: CCCCCCCCCC1CCCC(=O)O1 ; CCCCCCCCC1(C)CCC(=O)O1 ; CCCCCCCCCC1(C)CCC(=O)O1 ; CCCCCCCCCCCC1CCC(=O)O1]

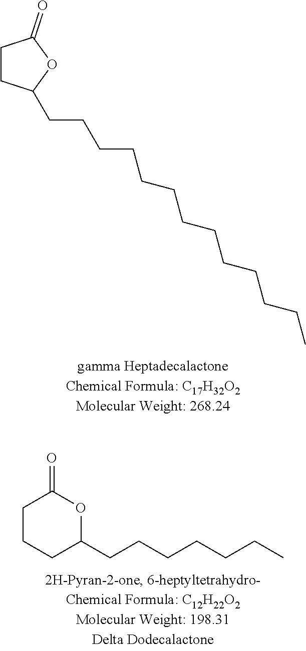 [SMILES: CCCCCCCCCCCCCC1CCC(=O)O1 ; CCCCCCCC1CCCC(=O)O1]

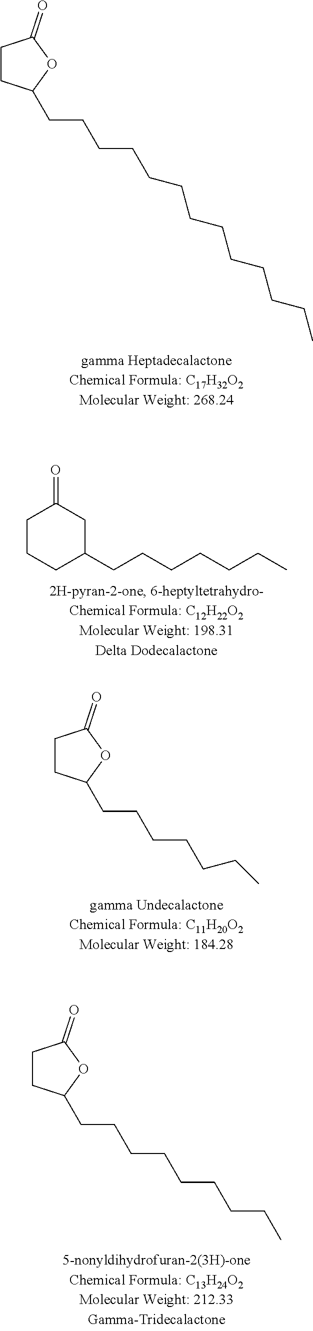 [SMILES: CCCCCCCCCCCCCC1CCC(=O)O1 ; CCCCCCCC1CCCC(=O)C1 ; CCCCCCCC1CCC(=O)O1 ; CCCCCCCCCC1CCC(=O)O1]

13. The method of claim 1 wherein the composition further comprises at least one adjuvant or additive selected from a group consisting of a carrier, wetting agents, adjuvants, emulsifiers, dispersants, spreaders, stickers, pastes, anchorage agents, fixatives, extenders, coating agents, buffering agents, pH adjusters, plant nutrients, absorptive additives, disintegrants, and combinations thereof.

14. The method of claim 1 wherein the composition comprises a liquid medium, wherein the liquid medium comprises the one or more compounds represented by the structure (A), optionally a surfactant, optionally an alcohol, optionally an oil, optionally a fixative selected from the group consisting of canola oil, castor oil, benzoyl benzoate, benzyl salicylate, synthetic musk, sandalwood, carnauba wax, carob gum, dextrin, dextrose, gellan gum, guar gum, paraffin wax, sorbitol, xanthan gum, polyvinylpyrrolidone, and glycerin; and optionally an absorptive additive selected from the group consisting of silica gel; precipitated crystalline-free silica gel; amorphous, fumed, crystalline-free silica; amorphous, precipitated gel silica; silica hydrate; vitreous silica; silicic acid; and silicon dioxide.

15. The method of claim 1, wherein the composition is applied to the plant or seed by a method selected from a group consisting of foliar application, soil application, seed treatment, injection onto plant tissues, and combinations thereof.

16. The method of claim 1, wherein the composition is applied to plant seeds, to germinating seedling roots before they are planted, or to roots of existing plants, or to seeds and plants after harvest and at storage, or is applied in situ, in the course of transfer, or introduced onto the bases of target plants.

17. The method of claim 1 wherein the composition is applied to plants or seeds to induce tolerance in the plants or seeds to biotic and abiotic stresses, or is applied to plants or seeds to induce tolerance in the plants or seeds to biotic stresses caused by bacteria, fungus, oomycetes, viruses, or insects, or is applied to plants or seeds to induce tolerance in the plants or seeds to abiotic stresses caused by low temperature/cold stress, freezing stress, high temperature/heat stress, salt/salinity stress, low light (shading stress), excessive light, ultraviolet (UV) radiation, other cosmic radiation, oxidative stress, heavy metal stress, lack of oxygen conditions, flooding, drought/water deficit, and/or a combination thereof.

18. The method of claim 1, wherein application of the composition to target plants or seeds results in localized or systemic biotic or abiotic stress tolerance throughout the plant or seed, or results in localized or systemic biotic or abiotic stress tolerance throughout the plant or seed during growth season or post-harvest.

19. The method of claim 1 wherein the protective response in the seed improves seed germination and seedling growth by altering seed vigor and/or the physiological state of the seed.

20. A composition for protecting a plant or seed from stress injury resulting from an environmental stress, said composition comprising one or more compounds represented by structure (A): 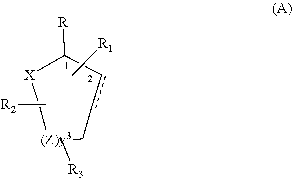
wherein:
R is selected from —OH, —O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the two or more compounds of structure (A);
wherein the one or more compounds represented by structure (A) are present in the composition in a protective amount sufficient to elicit a protective response in the plant or seed to the environmental stress; and
wherein, when the composition is for protecting a seed from stress injury resulting from an environmental stress, the one or more compounds represented by structure (A) are other than a jasmonate.

21. A method of inducing tolerance in a plant or seed to an environmental stress, said method comprising applying to at least a portion of said plant or seed a composition comprising one or more compounds represented by structure (A) of claim 20.

22. An environmental stress-tolerant plant or seed produced by the method of claim 1.

23. An environmental stress-tolerant plant or seed treated with the composition of claim 20.

24. A method of protecting a plant or seed from stress injury resulting from an environmental stress, said method comprising applying to at least a portion of said plant or seed a synergistic composition comprising a synergistic combination of two or more compounds represented by structure (A) in claim 20.

25. A method of seed treatment, said method comprising applying to at least a portion of said seed a composition comprising one or more compounds represented by structure (A) in claim 20.

26. A seed treated by the method of claim 25.
